(19) United States
(12) Patent Application Publication
(10) Pub. No.: US 2007/0300309 A1
(43) Pub. Date: Dec. 27, 2007

(54) Contents-data using system

(75) Inventor: Joji Naito, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/889,367

(22) Filed: Aug. 13, 2007

Related U.S. Application Data
(63) Continuation-in-part of application No. 11/118,325, filed on May 2, 2005.

(30) Foreign Application Priority Data
Sep. 8, 2006 (JP) 2006-243789

(51) Int. Cl. G06F 17/00

(52) U.S. Cl. 726/27

(57) ABSTRACT

Each of data using apparatuses generates a history information piece which represents a term of the use of content data and a received user ID while relating them with each other. The history information piece is sent to a managing apparatus. In each of the data using apparatuses, the use of the content data is prohibited when a user ID in a multiple use notice sent from the managing apparatus is equal to the received user ID. In the case where at least two of terms represented by history information pieces sent from the data using apparatuses are related with a same user ID and at least partially overlap each other, the managing apparatus generates a multiple use notice inclusive of the same user ID. The generated multiple use notice is sent to the data using apparatuses.

### CROSS-REFERENCE TO RELATED APPLICATIONS

This application is a continuation-in-part of U.S. patent application Ser. No. 11/118,325 filed on May 2, 2005.

### BACKGROUND OF THE INVENTION

1. Field of the Invention

This invention relates to a contents-data using system, a data using apparatus, a use-history-information managing apparatus, and a contents-data distributing apparatus designed to prevent illegal use of contents data.

2. Description of the Related Art

There is a network-based information service system in which many user's terminals and a server managed by a provider are connected via the Internet. A licensed user obtains a desired content data piece as follows. The licensed user operates user's terminal to send user ID to the provider via the Internet. The provider authenticates the incoming user ID. The licensed user operates the user's terminal to send a content ID for a desired content data piece to the provider via the Internet. After the authentication is completed, the provider searches content data pieces in the server for the desired content data piece in response to the incoming content ID and then sends the desired content data piece from the server to the user's terminal via the Internet or permits the user to access the desired content data piece through the user's terminal and the Internet.

In the above system, licenses are granted on a user-by-user basis rather than a terminal-by-terminal basis. Thus, the authentication is performed on a user ID rather than a terminal ID. Accordingly, a user having a plurality of terminals can use a desired content data piece or pieces in the server through any one of the terminals.

A consideration will now be given of the case where different terminals notify a same user ID to the provider, and simultaneously use a content data piece or pieces in the server. Such overlap data use is caused when different users illegally own the same user ID in common, and simultaneously access a content data piece or pieces in the server through their terminals. The overlap data use is against provider's interests.

Japanese patent application publication number 2003-84852 discloses a license managing server including a purchase information acquiring section, an identification information acquiring section, an identifying section, a license issuing section, and a license invalidating section. The purchase information acquiring section operates to acquire purchase information representing that software to be managed has been purchased. The identification information acquiring section operates to acquire user information for identifying a user, terminal identification information for identifying a user terminal, and individual product information for identifying the to-be-managed software. The identifying section operates to identify the user, the user terminal, and the to-be-managed software on the basis of the user information, the terminal identification information, and the individual product information. The license issuing section operates to retrieve license information, and issue a license based on a preset contract and send it to the user terminal through the Internet. The license permits the user to use the to-be-managed software. When the use of the to-be-managed software ends, the license invalidating section transmits a notice of the invalidation of the license to the user terminal through the Internet.

In Japanese application 2003-84852, the use of the to-be-managed software makes it necessary for the user to always connect the user terminal with the license managing server via the Internet. In the case where the user requests the use of the to-be-managed software after the user terminal is loaded with the to-be-managed software via the Internet and is then disconnected from the license managing server, it is difficult to implement the licensing procedure. Thus, the license managing server is unsuited for licensing a portable player which can be operated while being disconnected from the Internet.

Japanese patent application publication number 2006-146867 discloses a data using apparatus including a data recording device for recording data, and a data using device for using data recorded by the data recording device. In the apparatus, first data use history information is generated in accordance with every use of data by the data using device. The first data use history information represents a starting time and an ending time of every use of data by the data using device. The first data use history information is sent toward an external. The apparatus receives second data use history information from the external. In the apparatus, calculation is made as to first data use terms between the starting times and the ending times represented by the first data use history information. Calculation is also made as to second data use terms between starting times and ending times represented by the second data use history information. A decision is made as to whether or not at least one of the first data use terms and at least one of the second data use terms overlap each other. Multiple apparatus use notice information is generated and issued when it is decided that at least one of the first data use terms and at least one of the second data use terms overlap each other.

Usually, the apparatus in Japanese application 2006-146867 can not detect illegal use of data on a user-by-user basis.

### SUMMARY OF THE INVENTION

It is a first object of this invention to provide a contents-data using system which can reliably prevent illegal use of contents data.

It is a second object of this invention to provide a data using apparatus which can reliably prevent illegal use of contents data.

It is a third object of this invention to provide a use-history-information managing apparatus which can reliably prevent illegal use of contents data.

It is a fourth object of this invention to provide a contents-data distributing apparatus which can reliably prevent illegal use of contents data.

A first aspect of this invention provides a contents-data using system comprising a plurality of data using apparatuses, and a use-history-information managing apparatus. Each of the data using apparatuses comprises first means for receiving a user ID; second means for using content data; third means for generating a use history information piece including a record data piece which represents a term of the use of content data by the second means and the user ID received by the first means, and which relates the term of the use of the content data by the second means and the user ID received by the first means with each other; fourth means for sending the use history information piece generated by the third means to the use-history-information managing apparatus; fifth means for receiving a multiple use notice from the use-history-information managing apparatus; sixth means for deciding whether or not a user ID in the multiple use notice received by the fifth means is equal to the user ID received by the first means; and seventh means for prohibiting the second means from using content data when the sixth means decides that the user ID in the multiple use notice received by the fifth means is equal to the user ID received by the first means. The use-history-information managing apparatus comprises eighth means for receiving use history information pieces from the data using apparatuses respectively; ninth means for deciding whether or not at least two of terms represented by record data pieces in the use history information pieces received by the eighth means are related with a same user ID and at least partially overlap each other; tenth means for, when the ninth means decides that at least two of terms represented by record data pieces in the use history information pieces received by the eighth means are related with a same user ID and at least partially overlap each other, generating a multiple use notice inclusive of the same user ID; and eleventh means for sending the multiple use notice generated by the tenth means to the data using apparatuses.

A second aspect of this invention provides a data using apparatus comprising first means for receiving a user ID; second means for using content data; third means for generating a use history information piece including a record data piece which represents a term of the use of content data by the second means and the user ID received by the first means, and which relates the term of the use of the content data by the second means and the user ID received by the first means with each other; fourth means for sending the use history information piece generated by the third means to an external apparatus; fifth means for receiving a multiple use notice from the external apparatus; sixth means for deciding whether or not a user ID in the multiple use notice received by the fifth means is equal to the user ID received by the first means; and seventh means for prohibiting the second means from using content data when the sixth means decides that the user ID in the multiple use notice received by the fifth means is equal to the user ID received by the first means.

A third aspect of this invention provides a use-history-information managing apparatus comprising first means for receiving use history information pieces from external apparatuses respectively; second means for deciding whether or not at least two of terms represented by record data pieces in the use history information pieces received by the first means are related with a same user ID and at least partially overlap each other; third means for, when the second means decides that at least two of the terms are related with a same user ID and at least partially overlap each other, generating a multiple use notice inclusive of the same user ID; and fourth means for sending the multiple use notice generated by the third means to the external apparatuses.

A fourth aspect of this invention provides a contents-data using system comprising a content-data distributing apparatus, a plurality of data using apparatuses, and a use-history-information managing apparatus. Each of the data using apparatuses comprises first means for receiving a user ID; second means for receiving content data from the content-data distributing apparatus; third means for using the content data received by the second means; fourth means for selectively permitting and prohibiting the use of the content data by the third means in response to content-use prohibiting information in the content data received by the second means; fifth means for generating a use history information piece including a record data piece which represents a term of the use of the content data by the third means and the user ID received by the first means, and which relates the term of the use of the content data by the third means and the user ID received by the first means with each other; and sixth means for sending the use history information piece generated by the fifth means to the use-history-information managing apparatus. The use-history-information managing apparatus comprises seventh means for receiving use history information pieces from the data using apparatuses respectively; eighth means for deciding whether or not at least two of terms represented by record data pieces in the use history information pieces received by the seventh means are related with a same user ID and at least partially overlap each other; ninth means for, when the eighth means decides that at least two of the terms are related with a same user ID and at least partially overlap each other, generating a multiple use notice inclusive of the same user ID; and tenth means for sending the multiple use notice generated by the ninth means to the content-data distributing apparatus. The content-data distributing apparatus comprises eleventh means for receiving a multiple use notice from the use-history-information managing apparatus; twelfth means for extracting a user ID from the multiple use notice received by the eleventh means; thirteenth means for generating content-use prohibiting information in response to the user ID extracted by the twelfth means; fourteenth means for generating first content data; fifteenth means for adding the content-use prohibiting information generated by the thirteenth means to the first content data generated by the fourteenth means to generate second content data; and sixteenth means for distributing the second content data generated by the fifteenth means.

A fifth aspect of this invention provides a content-data distributing apparatus comprising first means for receiving a multiple use notice from an external apparatus; second means for extracting a user ID from the multiple use notice received by the first means; third means for generating content-use prohibiting information in response to the user ID extracted by the second means; fourth means for generating first content data; fifth means for adding the content-use prohibiting information generated by the third means to the first content data generated by the fourth means to generate second content data; and six means for distributing the second content data generated by the fifth means.

A sixth aspect of this invention provides a contents-data using system comprising a plurality of data using apparatuses each including a data using device for using content data, and an input device for receiving a user ID before the data using device uses content data; first means for deciding whether or not at least two apparatuses which have received a same user ID use content data during respective terms at least partially overlapping each other, the at least two apparatuses being among the data using apparatuses; second means for, in cases where the first means decides that at least two apparatuses which have received a same user ID use content data during respective terms at least partially overlapping each other, designating the same user ID as a specified user ID; third means for deciding whether or not a user ID newly received by any one of the data using apparatuses is equal to the specified user ID; and fourth means for, when the third means decides that a user ID newly received by any one of the data using apparatuses is equal to the specified user ID, prohibiting the one of the data using apparatuses from using content data.

A seventh aspect of this invention provides a method in a contents-data using system comprising a plurality of data using apparatuses each including a data using device for using content data, and an input device for receiving a user ID before the data using device uses content data. The method comprises the steps of deciding whether or not at least two apparatuses which have received a same user ID use content data during respective terms at least partially overlapping each other, the at least two apparatuses being among the data using apparatuses; in cases where it is decided that at least two apparatuses which have received a same user ID use content data during respective terms at least partially overlapping each other, designating the same user ID as a specified user ID; deciding whether or not a user ID newly received by any one of the data using apparatuses is equal to the specified user ID; and when it is decided that a user ID newly received by any one of the data using apparatuses is equal to the specified user ID, prohibiting the one of the data using apparatuses from using content data.

This invention has advantages as indicated below. A contents-data using system includes a plurality of data using apparatuses. Users are previously given different user identification information pieces, respectively. Before using a content data piece in each of the data using apparatuses, a user is required to input a related user identification information piece into the data using apparatus. In the contents-data using system, it is possible to prevent the following illegal use of a content data piece or pieces. A same user identification information piece is inputted into at least two data using apparatuses, and a content data piece or pieces are simultaneously used therein.

In an information service system where licenses are granted on a user-by-user basis, a user can use a content data piece in any of data using apparatuses when inputting a related user identification information piece thereinto. Basically, it is unnecessary for a user to obtain a new license when the user changes a data using apparatus from one to another.

### BRIEF DESCRIPTION OF THE DRAWINGS

FIG. 1 is a block diagram of a data using apparatus according to a first embodiment of this invention.

FIG. 2 is a diagram of the structure of data use history information in the first embodiment of this invention.

FIG. 3 is a block diagram of a data using apparatus according to a second embodiment of this invention.

FIG. 4 is a diagram of the structure of a data container in a third embodiment of this invention.

FIG. 5 is a diagram of the structure of data use history information in the third embodiment of this invention.

FIG. 6 is a diagram of a portion of data use history information indicating that there are three data using apparatuses.

FIG. 7 is a time-domain diagram showing an example of the conditions of the multiple use of data which corresponds to the data use history information in FIG. 6.

FIG. 8 is a block diagram of a data using apparatus according to a sixth embodiment of this invention.

FIG. 9 is a flowchart of a first segment of a control program for a control circuit in FIG. 8.

FIG. 10 is a flowchart of a second segment of the control program.

FIG. 11 is a flowchart of a segment of the control program which may replace the program segment in FIG. 10.

FIG. 12 is a diagram of a contents-data broadcasting and receiving system according to a seventh embodiment of this invention.

FIG. 13 is a diagram of a portion of the system in FIG. 12.

FIG. 14 is a block diagram of a first example of a receiver terminal in FIG. 13.

FIG. 15 is a diagram of the structure of a user history information piece.

FIG. 16 is a block diagram of a first example of a use-condition managing apparatus in FIG. 13.

FIG. 17 is a block diagram of a second example of the receiver terminal in FIG. 13.

FIG. 18 is a flowchart of a segment of a control program for a computer in FIG. 17.

FIG. 19 is a block diagram of a second example of the use-condition managing apparatus in FIG. 13.

FIG. 20 is a flowchart of a segment of a control program for a computer in FIG. 19.

FIG. 21 is a diagram of a contents-data distribution system according to an eighth embodiment of this invention.

FIG. 22 is a diagram of a portion of the system in FIG. 21.

FIG. 23 is a block diagram of a user terminal in FIG. 22.

FIG. 24 is a block diagram of a first example of a content-data distribution server in FIG. 22.

FIG. 25 is a block diagram of a second example of the content-data distribution server in FIG. 22.

FIG. 26 is a flowchart of a control program for a computer in FIG. 25.

### DETAILED DESCRIPTION OF THE INVENTION

### First Embodiment

According to a first embodiment of this invention, attribute information pieces are assigned to data using apparatuses, respectively. The attribute information pieces are peculiar to the related data using apparatuses, respectively.

Each attribute information piece is arbitrarily decided by a user of a related data using apparatus. Each attribute information piece represents, for example, the name of a user of a related data using apparatus or the nickname of the related data using apparatus. Each attribute information piece may be a unique information piece decided in conformity with given prescriptions.

In the case where toll contents are sold to a person, an information piece for identifying the person is used as an attribute information piece which should be assigned to a data using apparatus permitted to use the toll contents. In this case, the person is allowed to copy the toll contents by referring to the attribute information piece and employing the data using apparatus. On the other hand, the copying of the toll contents onto other data using apparatuses is limited.

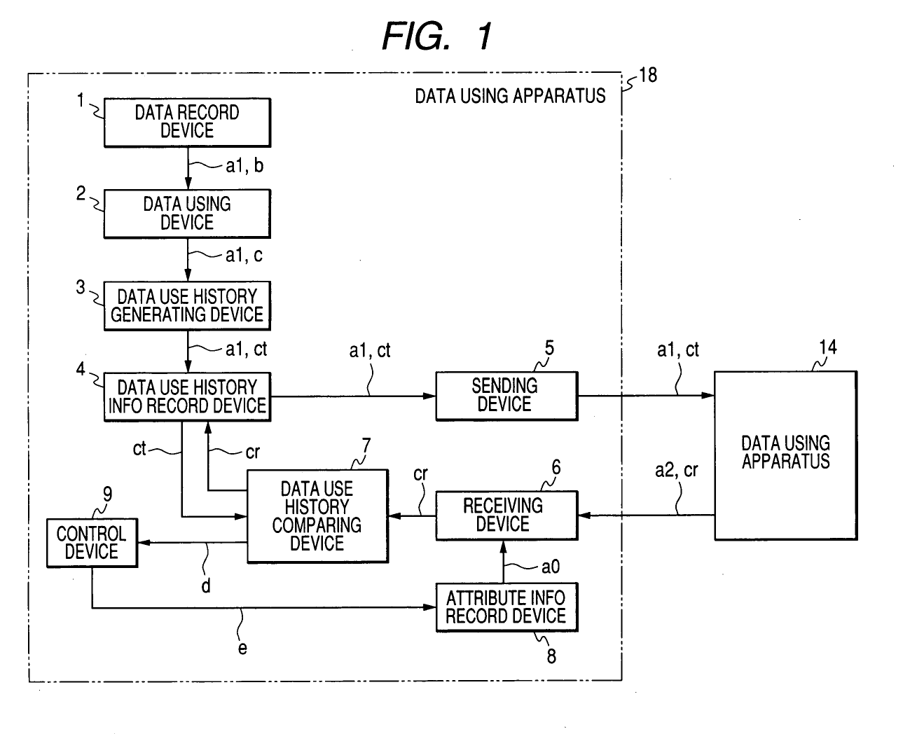

FIG. 1 shows a data using apparatus 18 according to the first embodiment of this invention. With reference to FIG. 1, the data using apparatus 18 includes an attribute information recording device 8 which holds an information piece a0 representing the attributes of the apparatus 18. The information piece a0 is referred to as the attribute information piece a0. The attribute information piece a0 is assigned to the data using apparatus 18. The attribute information piece a0 is peculiar to the data using apparatus 18. The attribute information recording device 8 contains, for example, a memory.

The data using apparatus 18 includes a data recording device 1 which holds an attribute information piece a1. The data recording device 1 is assigned the attribute information piece a1. Provided that the data recording device 1 is legitimate with respect to the data using apparatus 18, the attribute information piece a1 is identical with the attribute information piece a0. The data recording device 1 holds data “b” whose contents correspond to one or more programs (files). In the data recording device 1, the attribute information piece a1 and the data “b” are arranged in a manner such as to be related with each other provided that the data “b” is legitimately assigned to the data recording device 1. The data recording device 1 also holds identification information about the data “b”. The data recording device 1 contains, for example, a storage unit or a combination of a hard disk and its drive.

It should be noted that the data “b” may have a portion indicating a related attribute information piece.

The data “b” and the identification information about the data “b” can be stored into the data recording device 1 from an external package medium or a communication network through a suitable interface (not shown). In this case, an attribute information piece assigned to a source of supplying the data “b” is also stored into the data recording device 1 from the external package medium or the communication network. The attribute information piece concerning the data supply source and the data “b” are arranged in the data recording device 1 in a manner such as to be related with each other.

In the data using apparatus 18, the data recording device 1 feeds the data “b”, the attribute information piece a1, and the data identification information to a data using device 2. An attribute information piece a3 is assigned to the data using device 2. The attribute information piece a3 is stored in a memory within the data using device 2. Provided that the data using device 2 is legitimate with respect to the data using apparatus 18, the attribute information piece a3 is identical with the attribute information piece a0. As previously mentioned, the attribute information piece a1 is normally identical with the attribute information piece a0.

According to a first example, the data using device 2 compares the fed attribute information piece a1 and the attribute-information-piece indicating portion of the data “b”. When the result of the comparison indicates that the attribute information piece a1 and the attribute-information-piece indicating portion of the data “b” are the same, the data using device 2 implements the use of the data “b” (for example, the recording of the data “b”, the copying of the data “b”, or the playback of the contents of the data “b”). At the same time, the data using device 2 passes the attribute information piece a1 to a data use history generating device 3. On the other hand, when the result of the comparison indicates that the attribute information piece a1 and the attribute-information-piece indicating portion of the data “b” are different, the data using device 2 inhibits the use of the data “b”.

According to a second example, the data using device 2 compares the fed attribute information piece a1 and the assigned attribute information piece a3. When the result of the comparison indicates that the attribute information pieces a1 and a3 are the same, the data using device 2 implements the use of the data “b” (for example, the recording of the data “b”, the copying of the data “b”, or the playback of the contents of the data “b”). At the same time, the data using device 2 passes the attribute information piece a1 to the data use history generating device 3. On the other hand, when the result of the comparison indicates that the attribute information pieces a1 and a3 are different, the data using device 2 inhibits the use of the data “b”.

The data using device 2 has identification information thereabout. The data using device 2 is notified of identification information about the data using apparatus 18. The data using device 2 generates data use information “c” in accordance with the use of the data “b” therein, the data identification information, and the apparatus identification information. The data use information “c” means information basically representing the conditions of the use of the data “b” in the data using device 2. Preferably, the data use information “c” has a piece representing the starting time c1 of the data use, a piece representing the ending time c2 of the data use, a piece containing the identification information c3 about the data “b”, and a piece containing the identification information c4 about the data using apparatus 18 or the data using device 2. The data using device 2 feeds the data use information “c” to the data use history generating device 3. The data using device 2 contains, for example, a data recording device, a data copying device, a data reproducing device, or a data player.

The data use history generating device 3 produces data use history information “ct” in response to the data use information “c”. For example, the data use history generating device 3 updates the data use history information “ct” in response to the data use information “c”. Specifically, the data use history generating device 3 adds the data use information “c” to the old data use history information “ct” to get the new data use history information “ct”. The data use history information “ct” means information basically representing the use history of the data “b”. The data use history generating device 3 feeds the data use history information “ct” to a data use history information recording device 4. The data use history generating device 3 passes the attribute information piece a1 to the data use history information recording device 4.

The data use history information recording device 4 stores the data use history information “ct” and the attribute information piece a1 therein. The data use history information recording device 4 contains, for example, a memory or a storage unit.

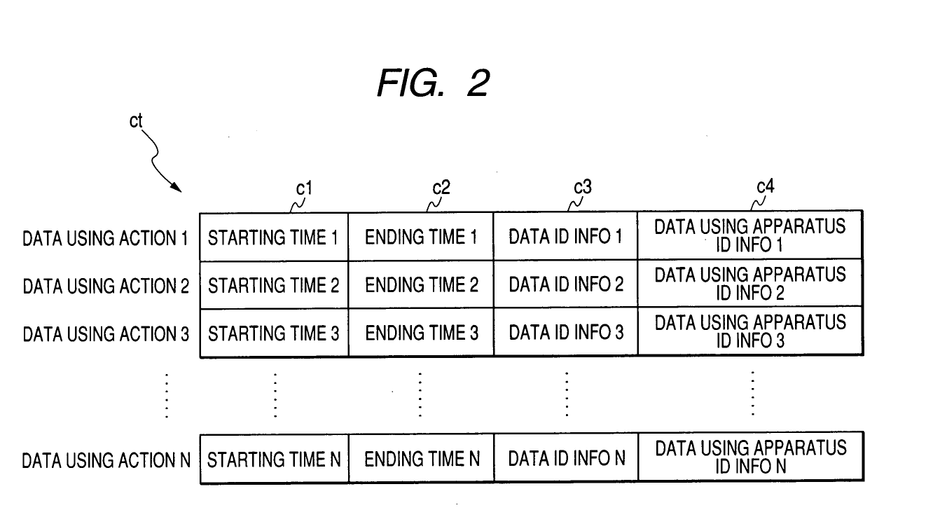

FIG. 2 shows the structure of the data use history information “ct”. As shown in FIG. 2, the data use history information “ct” is divided into row segments assigned to respective data using actions (for example, data recording actions) “1”, “2”, . . . , “N” performed by the data using device 2 or other data using devices. Each of the history-information row segments corresponds to data use information “c” generated by the data using device 2 or another data using device. Specifically, each of the history-information row segments has a piece representing the starting time c1 of the related data use, a piece representing the ending time c2 of the related data use, a piece containing identification information c3 about the related data, and a piece containing identification information c4 about a data using apparatus or a data using device (for example, the data using apparatus 18 or the data using device 2) implementing the related data use. The data-use starting time c1 and the data-use ending time c2 are expressed in units of year, month, day, hour, minute, and second. The data-use starting time c1 and the data-use ending time c2 may be expressed in other units. It should be noted that the data identification information c3 may be omitted from each row segment of the data use history information “ct”.

With reference back to FIG. 1, the data using apparatus 18 includes a sending device 5 and a receiving device 6. The data using apparatus 18 can be connected with another data using apparatus 14. The data using apparatus 14 may be similar in structure to the data using apparatus 18. When the data using apparatus 18 is connected with the data using apparatus 14, the sending device 5 and the receiving device 6 in the data using apparatus 18 are coupled with a receiving device and a sending device in the data using apparatus 14 respectively.

In the data using apparatus 18, the data use history information recording device 4 feeds the data use history information “ct” and the attribute information piece a1 to the sending device 5. When the data using apparatus 18 is connected with the data using apparatus 14, the sending device 5 in the data using apparatus 18 sends the data use history information “ct” and the attribute information piece a1 to the data using apparatus 14. The receiving device 6 in the data using apparatus 18 receives data use history information “cr” and an attribute information piece a2 from the data using apparatus 14.

The receiving device 6 reads out the attribute information piece a0 from the attribute information recording device 8 provided that the use of the attribute information piece a0 is allowed. The receiving device 6 includes a comparator for deciding whether or not the attribute information pieces a0 and a2 are the same. When the attribute information pieces a0 and a2 are the same, the receiving device 6 passes the data use history information “cr” to a data use history comparing device 7. On the other hand, when the attribute information pieces a0 and a2 are not the same, the receiving device 6 does not pass the data use history information “cr” to the data use history comparing device 7. When the use of the attribute information piece a0 is inhibited, the receiving device 6 does not pass the data use history information “cr” to the data use history comparing device 7.

In the data using apparatus 18, the data use history comparing device 7 reads out the data use history information “ct” from the data use history information recording device 4. The data use history comparing device 7 compares the data use history information “ct” and the data use history information “cr”. Specifically, the data use history comparing device 7 refers to the data-use starting time c1 and the data-use ending time c2 in each of the row segments of the data use history information “ct”, and calculates the data use term Tct between the data-use starting time c1 and the data-use ending time c2. Thus, the data use history comparing device 7 gets the data use terms Tct1, Tct2, . . . , TctN of data using actions corresponding to the respective row segments of the data use history information “ct”. In addition, the data use history comparing device 7 refers to the data-use starting time c1 and the data-use ending time c2 in each of the row segments of the data use history information “cr”, and calculates the data use term Tcr between the data-use starting time c1 and the data-use ending time c2. Thus, the data use history comparing device 7 gets the data use terms Tcr1, Tcr2, . . . , TcrM of data using actions corresponding to the respective row segments of the data use history information “cr”. The data use history comparing device 7 compares the group of the data use terms Tct1, Tct2, . . . , TctN and the group of the data use terms Tcr1, Tcr2, . . . , TcrM to find overlapping data use terms in the respective groups. When overlapping data use terms are in the respective groups, the data use history comparing device 7 decides whether or not the identification information c4 in one of the history-information row segments corresponding to the overlapping data use terms denotes the data using apparatus 18. In the case where the identification information c4 in one of the history-information row segments corresponding to the overlapping data use terms denotes the data using apparatus 18, the data use history comparing device 7 issues multiple apparatus use notice information (duplicate apparatus use notice information) “d” to a control device 9. Otherwise, the data use history comparing device 7 does not issue any multiple apparatus use notice information “d”.

It should be noted that the data use history comparing device 7 may be modified to perform the following operation steps. When overlapping data use terms are in the respective groups, the data use history comparing device 7 issues the multiple apparatus use notice information “d” to the control device 9. Otherwise, the data use history comparing device 7 does not issue any multiple apparatus use notice information “d”.

The control device 9 generates control information “e” in response to the multiple apparatus use notice information “d”. The control information “e” is designed to force the attribute information recording device 8 to limit the use of the attribute information piece a0. The control device 9 feeds the control information “e” to the attribute information recording device 8. The attribute information recording device 8 limits the use of the attribute information piece a0 in response to the control information “e”. Examples of the limitation are as follows. According to a first example, the attribute information recording device 8 continuously inhibits the attribute information piece a0 from being used by the receiving device 6 for a predetermined time interval. According to a second example, the attribute information recording device 8 continuously inhibits the attribute information piece a0 from being used by the receiving device 6 until control information for cancel is received from an external apparatus. Inhibiting the use of the attribute information piece a0 means disabling the attribute information piece a0. Furthermore, the inhibition of the use of the attribute information piece a0 substantially disables the receiving device 6 so that a main portion of the data using apparatus 18 can not receive data use history information “cr” from another data using apparatus.

The data use history comparing device 7 passes the data use history information “cr” to the data use history information recording device 4. The data use history information recording device 4 stores the data use history information “cr” therein. Specifically, the data use history information recording device 4 updates the stored data use history information “ct” in response to the data use history information “cr”. In more detail, the data use history information recording device 4 adds the data use history information “cr” to the old data use history information “ct” to get the new data use history information “ct”.

As previously mentioned, attribute information pieces are assigned to data using apparatuses respectively. Some of the attribute information pieces assigned to the data using apparatuses are the same. The data using apparatuses having the same attribute information piece are in a group for management. The data using apparatuses in the group can be managed. A main portion of each data using apparatus in the group is inhibited from communicating with a data using apparatus outside the group. Each of the data using apparatuses holds data use history information which is updated upon the use of data. When first and second ones of the data using apparatuses in the group are connected, first data use history information is transmitted from the first apparatus to the second apparatus and second data use history information is transmitted from the second apparatus to the first apparatus. In the case where the first data use history information and the second data use history information are in specified conditions, multiple apparatus use notice information (duplicate apparatus use notice information) “d” is generated in at least one of the first and second data using apparatuses. In the first data using apparatus, the second data use history information is added to the first data use history information to form new first data use history information. Similarly, in the second data using apparatus, the first data use history information is added to the second data use history information to form new second data use history information. The new first data use history information and the new second data use history information are identical in contents with each other. In the case where connections between apparatuses in all possible pairs in the group have been performed, all the data using apparatuses in the group have the same data use history information whose components are equal to the original data use history information in the apparatuses.

### Second Embodiment

A second embodiment of this invention employs attribute information pieces similar to those in the first embodiment of this invention.

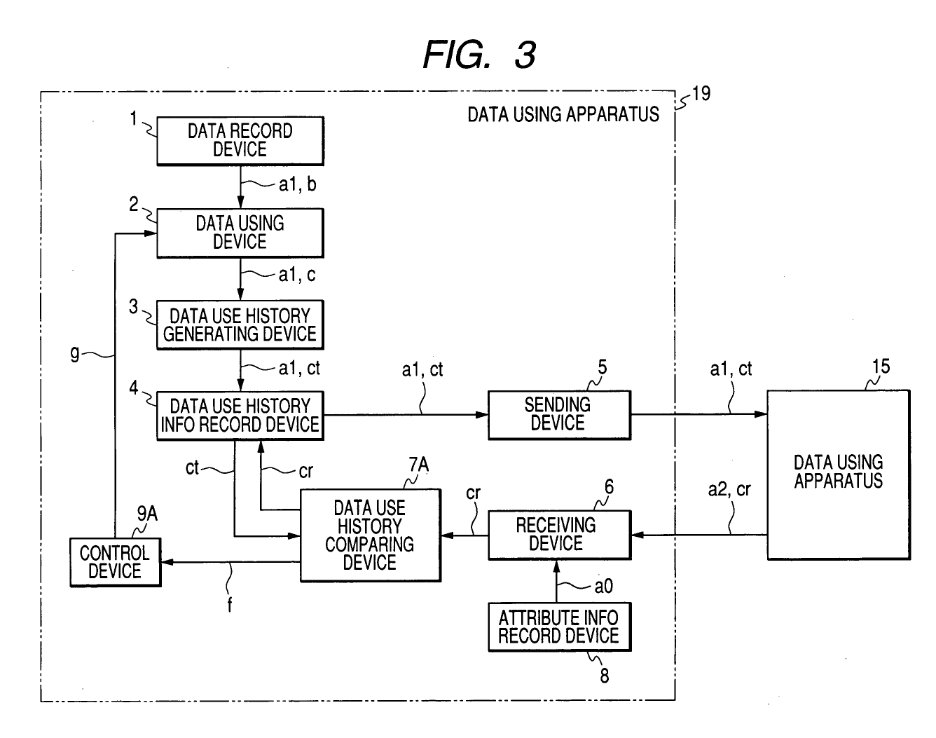

FIG. 3 shows a data using apparatus 19 according to the second embodiment of this invention. The data using apparatus 19 is basically similar to the data using apparatus 18 in FIG. 1 except for design changes mentioned later. As shown in FIG. 3, the data using apparatus 19 includes an attribute information recording device 8 which holds an information piece a0 representing the attributes of the apparatus 19.

The data using apparatus 19 also includes a data recording device 1 which holds an attribute information piece a1. The data recording device 1 is assigned the attribute information piece a1. Provided that the data recording device 1 is legitimate with respect to the data using apparatus 19, the attribute information piece a1 is identical with the attribute information piece a0. The data recording device 1 holds data “b” whose contents are one or more programs (files). The data recording device 1 also holds identification information about the data “b”. In the data recording device 1, the attribute information piece a1 and the data “b” are arranged in a manner such as to be related with each other provided that the data “b” is legitimately assigned to the data recording device 1.

It should be noted that the data “b” has a portion indicating a related attribute information piece.

The data “b” and the identification information about the data “b” can be stored into the data recording device 1 from an external package medium or a communication network through a suitable interface (not shown). In this case, an attribute information piece assigned to a source of supplying the data “b” is also stored into the data recording device 1 from the external package medium or the communication network. The attribute information piece concerning the data supply source and the data “b” are arranged in the data recording device 1 in a manner such as to be related with each other.

In the data using apparatus 19, the data recording device 1 feeds the data “b”, the attribute information piece a1, and the data identification information to a data using device 2. An attribute information piece a3 is assigned to the data using device 2. When the data using device 2 is legitimate with respect to the data using apparatus 19, the attribute information piece a3 is identical with the attribute information piece a0. As previously mentioned, the attribute information piece a1 is normally identical with the attribute information piece a0.

According to a first example, the data using device 2 compares the fed attribute information piece a1 and the attribute-information-piece indication portion of the data “b”. When the result of the comparison indicates that the attribute information piece a1 and the attribute-information-piece indication portion of the data “b” are the same, the data using device 2 implements the use of the data “b” (for example, the recording of the data “b”, the copying of the data “b”, or the playback of the contents of the data “b”). At the same time, the data using device 2 passes the attribute information piece a1 to a data use history generating device 3. On the other hand, when the result of the comparison indicates that the attribute information piece a1 and the attribute-information-piece indication portion of the data “b” are different, the data using device 2 inhibits the use of the data “b”.

According to a second example, the data using device 2 compares the fed attribute information piece a1 and the assigned attribute information piece a3. When the result of the comparison indicates that the attribute information pieces a1 and a3 are the same, the data using device 2 implements the use of the data “b” (for example, the recording of the data “b”, the copying of the data “b”, or the playback of the contents of the data “b”). At the same time, the data using device 2 passes the attribute information piece a1 to the data use history generating device 3. On the other hand, when the result of the comparison indicates that the attribute information pieces a1 and a3 are different, the data using device 2 inhibits the use of the data “b”.

The data using device 2 has identification information thereabout. The data using device 2 is notified of identification information about the data using apparatus 19. The data using device 2 generates data use information “c” in accordance with the use of the data “b” therein, the data identification information, and the apparatus identification information. The data use information “c” means information basically representing the conditions of the use of the data “b” in the data using device 2. Preferably, the data use information “c” has a piece representing the starting time c1 of the data use, a piece representing the ending time c2 of the data use, a piece containing the identification information c3 about the data “b”, and a piece containing the identification information c4 about the data using apparatus 19 or the data using device 2. The data using device 2 feeds the data use information “c” to the data use history generating device 3.

The data use history generating device 3 produces data use history information “ct” in response to the data use information “c”. For example, the data use history generating device 3 updates the data use history information “ct” in response to the data use information “c”. Specifically, the data use history generating device 3 adds the data use information “c” to the old data use history information “ct” to get the new data use history information “ct”. The data use history information “ct” means information basically representing the use history of the data “b”. The data use history generating device 3 feeds the data use history information “ct” to a data use history information recording device 4. The data use history generating device 3 passes the attribute information piece a1 to the data use history information recording device 4.

The data use history information recording device 4 stores the data use history information “ct” and the attribute information piece a1 therein. The data use history information “ct” has a structure similar to that in FIG. 2.

As shown in FIG. 3, the data using apparatus 19 includes a sending device 5 and a receiving device 6. The data using apparatus 19 can be connected with another data using apparatus 15. The data using apparatus 15 may be similar in structure to the data using apparatus 19. When the data using apparatus 19 is connected with the data using apparatus 15, the sending device 5 and the receiving device 6 in the data using apparatus 19 are coupled with a receiving device and a sending device in the data using apparatus 15 respectively.

In the data using apparatus 19, the data use history information recording device 4 feeds the data use history information “ct” and the attribute information piece a1 to the sending device 5. When the data using apparatus 19 is connected with the data using apparatus 15, the sending device 5 in the data using apparatus 19 sends the data use history information “ct” and the attribute information piece a1 to the data using apparatus 15. The receiving device 6 in the data using apparatus 19 receives data use history information “cr” and an attribute information piece a2 from the data using apparatus 15.

The receiving device 6 reads out the attribute information piece a0 from the attribute information recording device 8 provided that the use of the attribute information piece a0 is allowed. The receiving device 6 includes a comparator for deciding whether or not the attribute information pieces a0 and a2 are the same. When the attribute information pieces a0 and a2 are the same, the receiving device 6 passes the data use history information “cr” to a data use history comparing device 7A. On the other hand, when the attribute information pieces a0 and a2 are not the same, the receiving device 6 does not pass the data use history information “cr” to the data use history comparing device 7A. When the use of the attribute information piece a0 is inhibited, the receiving device 6 does not pass the data use history information “cr” to the data use history comparing device 7A.

In the data using apparatus 19, the data use history comparing device 7A passes the data use history information “cr” to the data use history information recording device 4. The data use history information recording device 4 stores the data use history information “cr” therein. Specifically, the data use history information recording device 4 updates the stored data use history information “ct” in response to the data use history information “cr”. In more detail, the data use history information recording device 4 adds the data use history information “cr” to the old data use history information “ct” to get the new data use history information “ct”.

The data use history comparing device 7A reads out the updated data use history information (the new data use history information) “ct” from the data use history information recording device 4. The data use history comparing device 7A refers to the data-use starting time c1 and the data-use ending time c2 in each of the row segments of the data use history information “ct”, and calculates the data use term Tct between the data-use starting time c1 and the data-use ending time c2. Thus, the data use history comparing device 7A gets the data use terms Tct1, Tct2, . . . , TctL of data using actions corresponding to the respective row segments of the data use history information “ct”. The data use history comparing device 7A searches the row segments of the data use history information “ct” for ones having the same data identification information c3. In addition, the data use history comparing device 7A searches the data use terms Tct1, Tct2, . . . , TctL for overlapping ones. Then, the data use history comparing device 7A decides whether or not there are similar ones among the row segments of the data use history information “ct” which have the same data identification information c3, and which relate to overlapping data use terms. Furthermore, the data use history comparing device 7A decides whether or not one of such similar row segments of the data use history information “ct” has the identification information c4 denoting the data using apparatus 19. In the case where there are such similar row segments of the data use history information “ct” and one of the similar row segments has the identification information c4 denoting the data using apparatus 19, the data use history comparing device 7A issues multiple data use notice information (duplicate data use notice information) “f” to a control device 9A. Otherwise, the data use history comparing device 7A does not issue any multiple data use notice information “f”. The multiple data use notice information “f” contains the above-indicated same data identification information c3.

The control device 9A generates control information “g” in response to the multiple data use notice information “f”. The control information “g” contains the above-indicated same data identification information c3. The control information “g” is designed to force the data using device 2 to limit the use of the data “b” identified by the above-indicated same data identification information c3. The control device 9A feeds the control information “g” to the data using device 2. In response to the control information “g”, the data using device 2 limits the use of the data “b” identified by the above-indicated same data identification information c3. Examples of the limitation are as follows. According to a first example, the data using device 2 continuously inhibits the use of the data “b” for a predetermined time interval. According to a second example, the data using device 2 continuously inhibits the use of the data “b” until control information for cancel is received from an external apparatus.

As previously mentioned, attribute information pieces are assigned to data using apparatuses respectively. Some of the attribute information pieces assigned to the data using apparatuses are the same. The data using apparatuses having the same attribute information piece are in a group for management. The data using apparatuses in the group can be managed. A main portion of each data using apparatus in the group is inhibited from communicating with a data using apparatus outside the group. Each of the data using apparatuses holds data use history information which is updated upon the use of data. When first and second ones of the data using apparatuses in the group are connected, first data use history information is transmitted from the first apparatus to the second apparatus and second data use history information is transmitted from the second apparatus to the first apparatus. In the first data using apparatus, the second data use history information is added to the first data use history information to form new first data use history information. Similarly, in the second data using apparatus, the first data use history information is added to the second data use history information to form new second data use history information. The new first data use history information and the new second data use history information are identical in contents with each other. When the new first data use history information is in specified conditions, multiple data use notice information (duplicate data use notice information) “f” is generated in the first data using apparatus. Similarly, when the new second data use history information is in specified conditions, multiple data use notice information (duplicate data use notice information) “f” is generated in the second data using apparatus. In the case where connections between apparatuses in all possible pairs in the group have been performed, all the data using apparatuses in the group have the same data use history information whose components are equal to the original data use history information in the apparatuses.

### Third Embodiment

A third embodiment of this invention is similar to the first or second embodiment thereof (see FIG. 1 or FIG. 3) except for the following points.

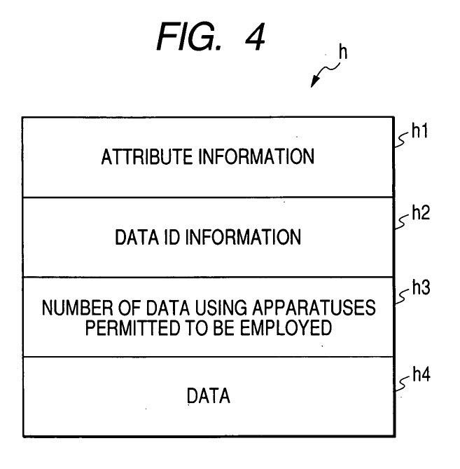

According to the third embodiment of this invention, the data “b” and the attribute information piece a1 in the data recording device 1 are in a data container “h”. As shown in FIG. 4, the data container “h” has a first section h1 loaded with the attribute information piece a1, a second section h2 loaded with identification information about the data “b”, a third section h3 loaded with information representing a predetermined number of data using apparatuses permitted to be employed, and a fourth section h4 loaded with the data “b”.

In the third embodiment of this invention, the data recording device 1 feeds the data “b”, the attribute information piece a1, the data identification information, and the apparatus number information to the data using device 2. In the case where the data using device 2 implements the use of the data “b”, the data using device 2 generates data use information “c” in accordance with the use of the data “b” therein, the data identification information, and the apparatus number information. The data use information “c” means information basically representing the conditions of the use of the data “b” in the data using device 2. Preferably, the data use information “c” has a piece representing the starting time c1 of the data use, a piece representing the ending time c2 of the data use, a piece containing identification information c3 about the data “b”, a piece containing identification information c4 about the data using apparatus 18 or the data using device 2, and a piece containing information c5 representing the predetermined number of data using apparatuses permitted to be employed. The data using device 2 feeds the data use information “c” to the data use history generating device 3. The data using device 2 passes the attribute information piece a1 to the data use history generating device 3.

The data use history generating device 3 produces data use history information “ct” in response to the data use information “c”. For example, the data use history generating device 3 updates the data use history information “ct” in response to the data use information “c”. Specifically, the data use history generating device 3 adds the data use information “c” to the old data use history information “ct” to get the new data use history information “ct”. The data use history information “ct” means information basically representing the use history of the data “b”. The data use history generating device 3 feeds the data use history information “ct” to the data use history information recording device 4. The data use history generating device 3 passes the attribute information piece a1 to the data use history information recording device 4.

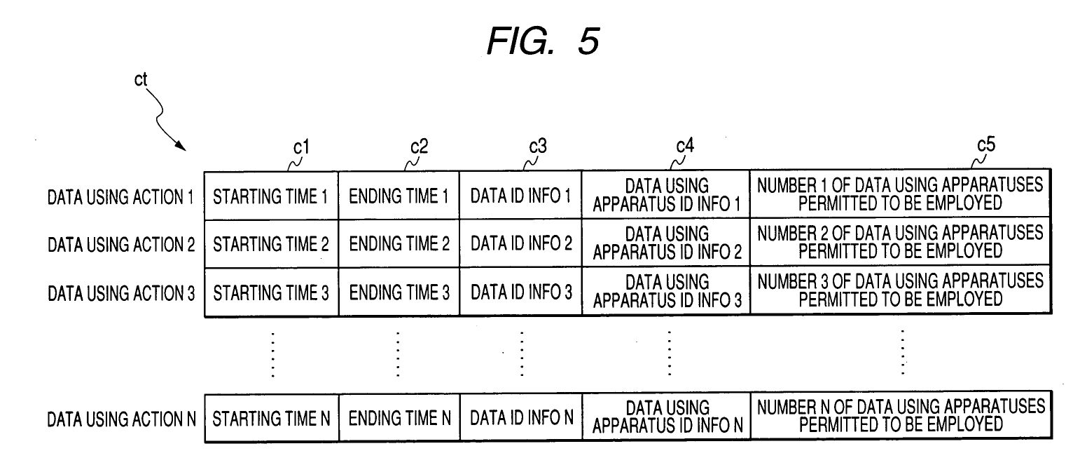

FIG. 5 shows the structure of the data use history information “ct” in the third embodiment of this invention. As shown in FIG. 5, the data use history information “ct” is divided into row segments assigned to respective data using actions (for example, data recording actions) “1”, “2”, . . . , “N” performed by the data using device 2 or other data using devices. Each of the history-information row segments corresponds to data use information “c” generated by the data using device 2 or another data using device 2. Specifically, each of the history-information row segments has a piece representing the starting time c1 of the related data use, a piece representing the ending time c2 of the related data use, a piece containing identification information c3 about the related data, a piece containing identification information c4 about a data using apparatus or a data using device (for example, the data using apparatus 18 or the data using device 2) implementing the related data use, and a piece containing information c5 representing the predetermined number of data using apparatuses permitted to be employed. The data-use starting time c1 and the data-use ending time c2 are expressed in units of year, month, day, hour, minute, and second. The data-use starting time c1 and the data-use ending time c2 may be expressed in other units. It should be noted that the data identification information c3 may be omitted from each row segment of the data use history information “ct”.

In the third embodiment of this invention, the data use history comparing device 7 reads out the data use history information “ct” from the data use history information recording device 4. The data use history comparing device 7 receives the data use history information “cr” from the receiving device 6. The data use history comparing device 7 refers to the data-use starting time c1 and the data-use ending time c2 in each of the row segments of the data use history information “ct” and the data use history information “cr”, and calculates the data use term Tct between the data-use starting time c1 and the data-use ending time c2. Thus, the data use history comparing device 7 gets the data use terms Tct1, Tct2, . . . , TctL of data using actions corresponding to the respective row segments of the data use history information “ct” and the data use history information “cr”. The data use history comparing device 7 searches the row segments of the data use history information “ct” and the data use history information “cr” for ones having the same data identification information c3. In addition, the data use history comparing device 7 searches the data use terms Tct1, Tct2, . . . , TctL for overlapping ones. Then, the data use history comparing device 7 decides whether or not there are similar ones among the row segments of the data use history information “ct” and the data use history information “cr” which have the same data identification information c3, and which relate to overlapping data use terms. Furthermore, the data use history comparing device 7 counts such similar row segments of the data use history information “ct” and the data use history information “cr”. Subsequently, the data use history comparing device 7 compares the number of the counted history-information row segments with the predetermined number of data using apparatuses permitted to be employed which corresponds to the above-indicated same data identification information c3. When the result of the comparison indicates that the number of the counted history-information row segments is greater than the predetermined number of data using apparatuses permitted to be employed, the data use history comparing device 7 issues multiple apparatus use notice information (duplicate apparatus use notice information) “d” to the control device 9. Otherwise, the data use history comparing device 7 does not issue any multiple apparatus use notice information “d”.

It should be noted that multiple data use notice information (duplicate data use notice information) “f” may be generated instead of the multiple apparatus use notice information “d”. In this case, the generated multiple data use notice information “f” is handled as mentioned in the second embodiment of this invention (see FIG. 3).

The data use history comparing device 7 may be modified to implement the following sequence of operation steps. The data use history comparing device 7 searches the data use terms Tct1, Tct2, . . . , TctL for overlapping ones. The data use history comparing device 7 counts row segments of the data use history information “ct” and the data use history information “cr” which correspond to the overlapping data use terms. Subsequently, the data use history comparing device 7 compares the number of the counted history-information row segments with the predetermined numbers of data using apparatuses permitted to be employed which are represented by the apparatus number information c5 in the counted history-information row segments. When the result of the comparison indicates that the number of the counted history-information row segments is greater than any of the predetermined numbers of data using apparatuses permitted to be employed, the data use history comparing device 7 issues multiple apparatus use notice information (duplicate apparatus use notice information) “d” to the control device 9 provided that the data using apparatus 18 is the same as one of apparatuses denoted by the apparatus identification information c4 in the counted history-information row segments. Otherwise, the data use history comparing device 7 does not issue any multiple apparatus use notice information “d”.

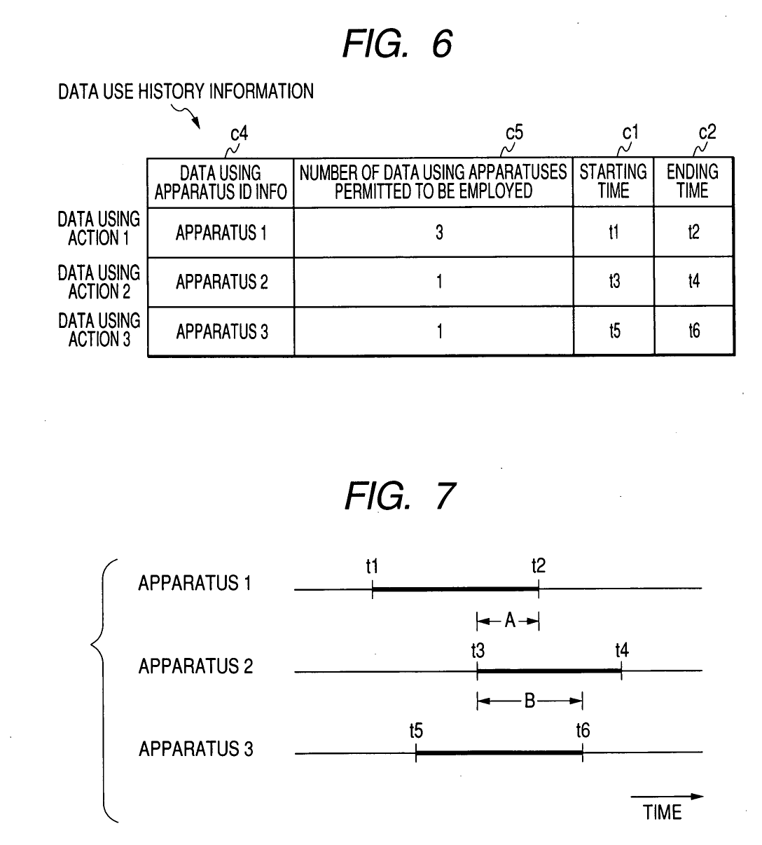

It is possible to grant a license to use data in multiple on a data-by-data basis. FIG. 6 shows an example of a portion of the data use history information “ct” or “cr” indicating that there are three data using apparatuses “1”, “2”, and “3”. The data use history information in FIG. 6 has first, second, and third row segments corresponding to data using actions “1”, “2”, and “3” respectively.

In FIG. 6, the first history-information row segment represents that data-use starting time c1 and data-use ending time c2 are moments t1 and t2 respectively. The first history-information row segment has apparatus identification information c4 denoting the data using apparatus “1”. The first history-information row segment has number information c5 representing that the predetermined number of data using apparatuses permitted to be employed is equal to 3. The second history-information row segment represents that data-use starting time c1 and data-use ending time c2 are moments t3 and t4 respectively. The second history-information row segment has apparatus identification information c4 denoting the data using apparatus “2”. The second history-information row segment has number information c5 representing that the predetermined number of data using apparatuses permitted to be employed is equal to 1. The third history-information row segment represents that data-use starting time c1 and data-use ending time c2 are moments t5 and t6 respectively. The third history-information row segment has apparatus identification information c4 denoting the data using apparatus “3”. The third history-information row segment has number information c5 representing that the predetermined number of data using apparatuses permitted to be employed is equal to 1.

FIG. 7 shows an example of the conditions of the multiple use of data which corresponds to the data use history information in FIG. 6. As shown in FIG. 7, the moments t1, t5, t3, t2, t6, and t4 are arranged in that order along time base. The data use by the data using apparatus “1”, the data use by the data using apparatus “2”, and the data use by the data using apparatus “3” entirely overlap each other during the time interval “A” between the moments t3 and t2. Thus, the multiplicity of the data use is equal to 3 during the time interval “A”. As shown in FIG. 6, the predetermined number represented by the number information c5 concerning the data using apparatus “1” is equal to 3. Therefore, the multiplicity of the data use does not exceed the predetermined number represented by the number information c5 concerning the data using apparatus “1” during the time interval “A”. Accordingly, any multiple apparatus use notice information “d” is not generated in the data using apparatus “1”. The data use by the data using apparatus “2” and the data use by the data using apparatus “3” entirely overlap each other during the time interval “B” between the moments t3 and t6. Thus, the multiplicity of the data use is equal to at least 2 during the time interval “B”. As shown in FIG. 6, the predetermined number represented by the number information c5 concerning each of the data using apparatuses “2” and “3” is equal to 1. Therefore, the multiplicity of the data use exceeds the predetermined number represented by the number information c5 concerning each of the data using apparatuses “2” and “3” during the time interval “B”. Accordingly, multiple apparatus use notice information “d” is generated in each of the data using apparatuses “2” and “3”.

### Fourth Embodiment

A fourth embodiment of this invention is similar to the second embodiment thereof (see FIG. 3) except that the data “b” and the attribute information piece a1 in the data recording device 1 are in the data container “h” (see FIG. 4).

### Fifth Embodiment

A fifth embodiment of this invention is similar to the second embodiment thereof (see FIG. 3) except for design changes mentioned later.

According to the fifth embodiment of this invention, the data use history comparing device 7A decides whether or not there are similar ones among the row segments of the data use history information “ct” which have the same data identification information c3, and which relate to overlapping data use terms. In the case where there are such similar row segments of the data use history information “ct”, the data use history comparing device 7A issues multiple data use notice information (duplicate data use notice information) “f” to the control device 9A. Otherwise, the data use history comparing device 7A does not issue any multiple data use notice information “f”. The multiple data use notice information “f” contains the above-indicated same data identification information c3.

### Sixth Embodiment

A sixth embodiment of this invention is similar to one of the first to fifth embodiments thereof except for design changes mentioned hereafter.

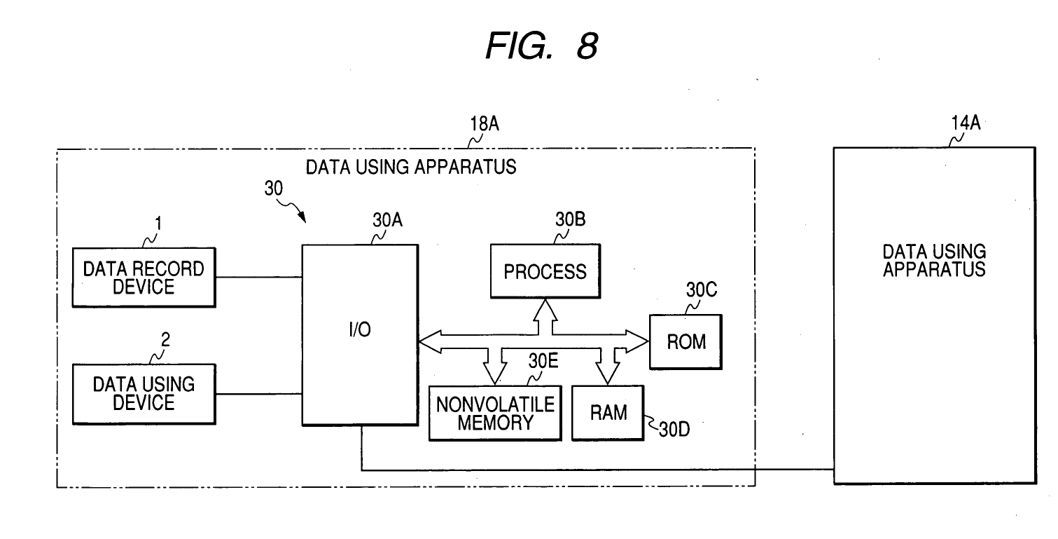

FIG. 8 shows a data using apparatus 18A according to the sixth embodiment of this invention. With reference to FIG. 8, the data using apparatus 18A includes a data recording device 1, a data using device 2, and a control circuit 30. The data recording device 1 and the data using device 2 are connected with the control circuit 30.

The control circuit 30 includes an input/output port (interface) 30A, a processing unit 30B, a ROM 30C, a RAM 30D, and a nonvolatile memory 30E connected to constitute a computer system. The control circuit 30 operates in accordance with a control program stored in the ROM 30C. An attribute information piece a0 assigned to the data using apparatus 18A is stored in the ROM 30C. Apparatus identification information c4 assigned to the data using apparatus 18A is also stored in the ROM 30C. Data use history information “ct” is stored in the nonvolatile memory 30E. The input/output port 30A is connected with the data recording device 1 and the data using device 2.

The data recording device 1 holds data “b”, an attribute information piece a1, identification information c3 about the data “b”, and information c5 representing a predetermined number of data using apparatuses permitted to be employed.

It should be noted that the data “b” has a portion indicating a related attribute information piece.

The data using device 2 includes a memory loaded with an attribute information piece a3 assigned thereto and also apparatus identification information c4 assigned thereto.

The data using apparatus 18A can be connected with another data using apparatus 14A. The data using apparatus 14A may be similar in structure to the data using apparatus 18A. When the data using apparatuses 18A is connected with the data using apparatus 14A, the input/output port 30A in the data using apparatus 18A is coupled with an input/output port in the data using apparatus 14A.

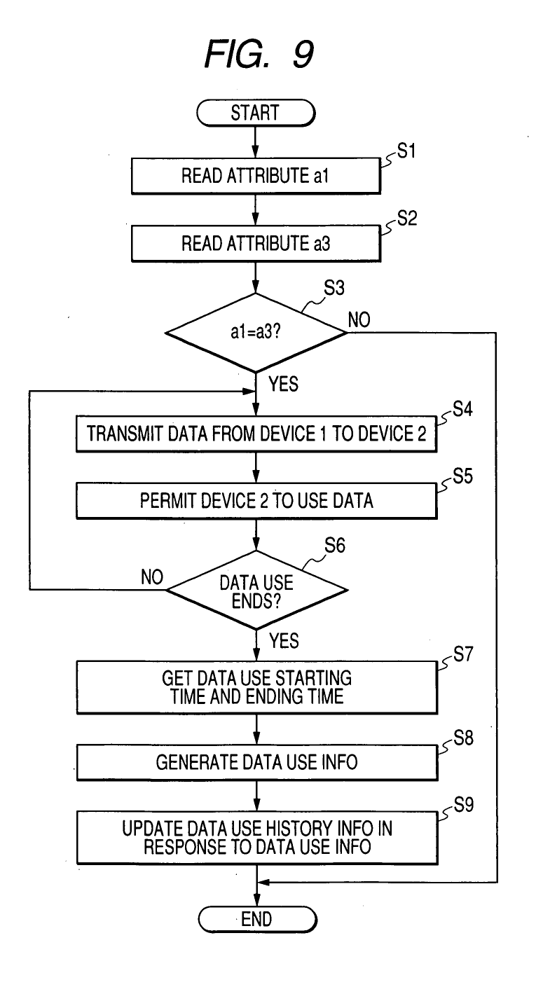

As previously mentioned, the control circuit 30 operates in accordance with the control program stored in the ROM 30C. FIG. 9 shows a first segment of the control program which is started when the data using device 2 requests the control circuit 30 to give data.

As shown in FIG. 9, a first step S1 of the program segment reads out the attribute information piece a1 from the data recording device 1.

A step S2 following the step S1 reads out the attribute information piece a3 from the memory within the data using device 2.

A step S3 is subsequent to the step S2. A first example of the step S3 is designed as follows. The step S3 decides whether or not the attribute information piece a1 and the attribute-information-piece indicating portion of the data “b” are the same. When the attribute information piece a1 and the attribute-information-piece indicating portion of the data “b” are the same, the program advances from the step S3 to a step S4. Otherwise, the program exits from the step S3 and then the current execution cycle of the program segment ends.

A second example of the step S3 is designed as follows. The step S3 decides whether or not the attribute information pieces a1 and a3 are the same. When the attribute information pieces a1 and a3 are the same, the program advances from the step S3 to the step S4. Otherwise, the program exits from the step S3 and then the current execution cycle of the program segment ends.

The step S4 controls the data recording device 1 to transmit the data “b” to the data using device 2.

The step S5 following the step S4 permits the data using device 2 to use the data “b”.

A step S6 subsequent to the step S5 checks operating conditions of the data using device 2 to decide whether or not the use of the data “b” ends. When the use of the data “b” ends, the program advances from the step S6 to a step S7. Otherwise, the program returns from the step S6 to the step S4.

The step S7 gets information representing the starting time c1 of the use of the data “b”, and information representing the ending time c2 of the use of the data “b”.

A step S8 following the step S7 reads out the data identification information c3 and the apparatus number information c5 from the data recording device 1. The step S8 retrieves the identification information c4 for the data using apparatus 18A. Alternatively, the step S8 may read out the identification information c4 for the data using device 2 from the memory within the data using device 2. The step S8 generates data use information “c” which has a piece representing the starting time c1 of the data use, a piece representing the ending time c2 of the data use, a piece containing the identification information c3 about the data “b”, a piece containing the identification information c4 about the data using apparatus 18 or the data using device 2, and a piece containing the information c5 representing the predetermined number of data using apparatuses permitted to be employed.

A step S9 subsequent to the step S8 updates the data use history information “ct” in the nonvolatile memory 30E in response to the data use information “c”. Specifically, the step S9 adds the data use information “c” to the old data use history information “ct” to get the new data use history information “ct”. In addition, the step S9 stores the attribute information piece a1 into the nonvolatile memory 30E. After the step S9, the current execution cycle of the program segment ends.

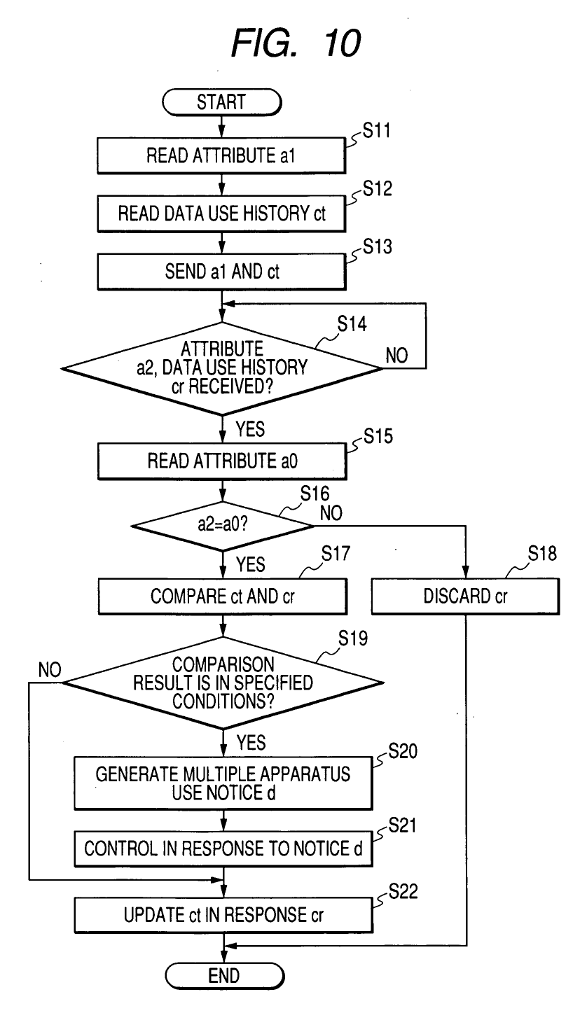

FIG. 10 shows a second segment of the control program for the control circuit 30 which is started when the data using apparatus 18A is connected with another data using apparatus (an opposite-party apparatus).

As shown in FIG. 10, a first step S11 of the program segment reads out the attribute information piece a1 from the nonvolatile memory 30E.

A step S12 following the step S11 reads out the data use history information “ct” from the nonvolatile memory 30E.

A step S13 subsequent to the step S12 sends the attribute information piece a1 and the data use history information “ct” to the opposite-party apparatus. After the step S13, the program advances to a step S14.

The step S14 decides whether or not an attribute information piece a2 and data use history information “cr” are received from the opposite-party apparatus. When the attribute information piece a2 and the data use history information “cr” are received, the program advances from the step S14 to a step S15. Otherwise, the step S14 is repeated.

The step S15 reads out the attribute information piece a0 from the ROM 30C.

A step S16 following the step S15 decides whether or not the attribute information pieces a0 and a2 are the same. When the attribute information pieces a0 and a2 are the same, the program advances from the step S16 to a step S17. Otherwise, the program advances from the step S16 to a step S18.

The step S18 discards the data use history information “cr”. After the step S18, the current execution cycle of the program segment ends.

The step S17 compares the data use history information “ct” and the data use history information “cr”. Specifically, the step S17 refers to the data-use starting time c1 and the data-use ending time c2 in each of the row segments of the data use history information “ct”, and calculates the data use term Tct between the data-use starting time c1 and the data-use ending time c2. Thus, the step S17 gets the data use terms Tct1, Tct2, . . . , TctN of data using actions corresponding to the respective row segments of the data use history information “ct”. In addition, the step S17 refers to the data-use starting time c1 and the data-use ending time c2 in each of the row segments of the data use history information “cr”, and calculates the data use term Tcr between the data-use starting time c1 and the data-use ending time c2. Thus, the step S17 gets the data use terms Tcr1, Tcr2, . . . , TcrM of data using actions corresponding to the respective row segments of the data use history information “cr”. The step S17 compares the group of the data use terms Tct1, Tct2, . . . , TctN and the group of the data use terms Tcr1, Tcr2, . . . , TcrM to find overlapping data use terms in the respective groups.

A step S19 following the step S17 decides whether or not the result of the comparison by the step S17 indicates that overlapping data use terms are in the respective groups. When the comparison result does not indicate that overlapping data use terms are in the respective groups, the program advances from the step S19 to a step S22. When the comparison result indicates that overlapping data use terms are in the respective groups, the step S19 decides whether or not the identification information c4 in one of the history-information row segments corresponding to the overlapping data use terms denotes the data using apparatus 18A. In the case where the identification information c4 in one of the history-information row segments corresponding to the overlapping data use terms denotes the data using apparatus 18, the program advances from the step S19 to a step S20. Otherwise, the program advances from the step S19 to the step S22.

The step S20 generates multiple apparatus use notice information (duplicate apparatus use notice information) “d”.

A step S21 subsequent to the step S20 generates control information “e” in response to the multiple apparatus use notice information “d”. The step S21 limits the read-out of the attribute information piece a0 from the ROM 30C in response to the control information “e”. Examples of the limitation are as follows. According to a first example, the step S21 continuously inhibits the read-out of the attribute information piece a0 from the ROM 30C for a predetermined time interval. According to a second example, the step S21 continuously inhibits the read-out of the attribute information piece a0 from the ROM 30C until control information for cancel is received from an external apparatus. Inhibiting the read-out of the attribute information piece a0 means disabling the attribute information piece a0. After the step S21, the program advances to the step S22.

The step S22 stores the data use history information “cr” into the nonvolatile memory 30E. Specifically, the step S22 updates the data use history information “ct” in the nonvolatile memory 30E in response to the data use history information “cr”. In more detail, the step S22 adds the data use history information “cr” to the old data use history information “ct” to get the new data use history information “ct”. After the step S22, the current execution cycle of the program segment ends.

It should be noted that the step S19 may be modified to perform the following actions. The step S19 decides whether or not the result of the comparison by the step S17 indicates that overlapping data use terms are in the respective groups. When the comparison result indicates that overlapping data use terms are in the respective groups, the program advances from the step S19 to the step S20. On the other hand, when the comparison result does not indicate that overlapping data use terms are in the respective groups, the program advances from the step S19 to the step S22.

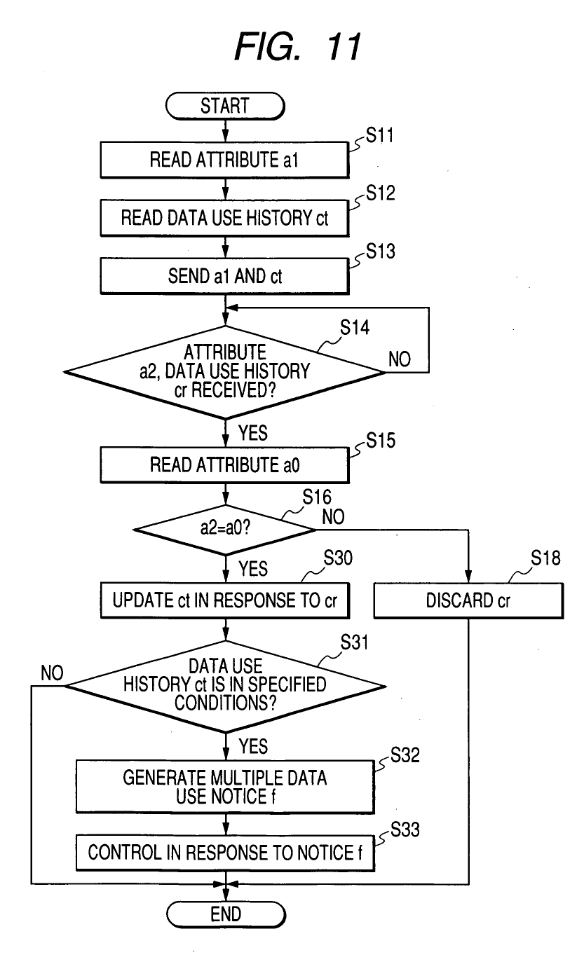

FIG. 11 shows a segment of the control program for the control circuit 30 which may replace the program segment in FIG. 10. The program segment in FIG. 11 differs from that in FIG. 10 as mentioned hereafter.

With reference to FIG. 11, the step S16 decides whether or not the attribute information pieces a0 and a2 are the same. When the attribute information pieces a0 and a2 are the same, the program advances from the step S16 to a step S30. Otherwise, the program advances from the step S16 to the step S18.

The step S30 stores the data use history information “cr” into the nonvolatile memory 30E. Specifically, the step S30 updates the data use history information “ct” in the nonvolatile memory 30E in response to the data use history information “cr”. In more detail, the step S30 adds the data use history information “cr” to the old data use history information “ct” to get the new data use history information “ct”.

A step S31 following the step S30 reads out the updated data use history information (the new data use history information) “ct” from the nonvolatile memory 30E. The step S31 refers to the data-use starting time c1 and the data-use ending time c2 in each of the row segments of the data use history information “ct”, and calculates the data use term Tct between the data-use starting time c1 and the data-use ending time c2. Thus, the step S31 gets the data use terms Tct1, Tct2, . . . , TctL of data using actions corresponding to the respective row segments of the data use history information “ct”. The step S31 searches the row segments of the data use history information “ct” for ones having the same data identification information c3. In addition, the step S31 searches the data use terms Tct1, Tct2, . . . , TctL for overlapping ones. Then, the step S31 decides whether or not there are similar ones among the row segments of the data use history information “ct” which have the same data identification information c3, and which relate to overlapping data use terms. Furthermore, the step S31 decides whether or not one of such similar row segments of the data use history information “ct” has the identification information c4 denoting the data using apparatus 18A. In the case where there are such similar row segments of the data use history information “ct” and one of the similar row segments has the identification information c4 denoting the data using apparatus 18A, the program advances from the step S31 to a step S32. Otherwise, the program exits from the step S31 and then the current execution cycle of the program segment ends.

The step S32 generates multiple data use notice information (duplicate data use notice information) “f”. The multiple data use notice information “f” contains the above-indicated same data identification information c3.

A step S33 following the step S32 generates control information “g” in response to the multiple data use notice information “f”. The control information “g” contains the above-indicated same data identification information c3. In response to the control information “g”, the step S33 forces the data using device 2 to limit the use of the data “b” identified by the above-indicated same data identification information c3. Examples of the limitation are as follows. According to a first example, the data using device 2 continuously inhibits the use of the data “b” for a predetermined time interval. According to a second example, the data using device 2 continuously inhibits the use of the data “b” until control information for cancel is received from an external apparatus. After the step S33, the current execution cycle of the program segment ends.

It should be noted that the step S31 may be modified to perform the following actions. The step S31 reads out the updated data use history information (the new data use history information) “ct” from the nonvolatile memory 30E. The step S31 refers to the data-use starting time c1 and the data-use ending time c2 in each of the row segments of the data use history information “ct”, and calculates the data use term Tct between the data-use starting time c1 and the data-use ending time c2. Thus, the step S31 gets the data use terms Tct1, Tct2, . . . , TctL of data using actions corresponding to the respective row segments of the data use history information “ct”. The step S31 searches the row segments of the data use history information “ct” for ones having the same data identification information c3. In addition, the step S31 searches the data use terms Tct1, Tct2, . . . , TctL for overlapping ones. Then, the step S31 decides whether or not there are similar ones among the row segments of the data use history information “ct” which have the same data identification information c3, and which relate to overlapping data use terms. In the case where there are similar ones among the row segments of the data use history information “ct” which have the same data identification information c3, and which relate to overlapping data use terms, the program advances from the step S31 to the step S32. Otherwise, the program exits from the step S31 and then the current execution cycle of the program segment ends.

It should be noted that the steps S31, S32, and S33 may be modified to perform the following actions. The step S31 decides whether or not there are similar ones among the row segments of the data use history information “ct” which have the same data identification information c3, and which relate to overlapping data use terms. Furthermore, the step S31 counts such similar row segments of the data use history information “ct”. Subsequently, the step S31 compares the number of the counted history-information row segments with the predetermined number of data using apparatuses permitted to be employed which corresponds to the above-indicated same data identification information c3. When the result of the comparison indicates that the number of the counted history-information row segments is greater than the predetermined number of data using apparatuses permitted to be employed, the program advances from the step S31 to the step S32. Otherwise, the program exits from the step S31 and then the current execution cycle of the program segment ends. The step S32 generates multiple apparatus use notice information (duplicate apparatus use notice information) “d”. Alternatively, the step S32 may generate multiple data use notice information (duplicate data use notice information) “f”. The step S33 generates control information “e” in response to the multiple apparatus use notice information “d”. The step S33 limits the read-out of the attribute information piece a0 from the ROM 30C in response to the control information “e”. Examples of the limitation are similar to the previously-mentioned ones. In the case where the step S32 generates the multiple data use notice information “f” rather than the multiple apparatus use notice information “d”, the step S33 generates control information “g” in response to the multiple data use notice information “f”. The control information “g” contains the above-indicated same data identification information c3. In response to the control information “g”, the step S33 forces the data using device 2 to limit the use of the data “b” identified by the above-indicated same data identification information c3. Examples of the limitation are similar to the previously-mentioned ones.

### Seventh Embodiment

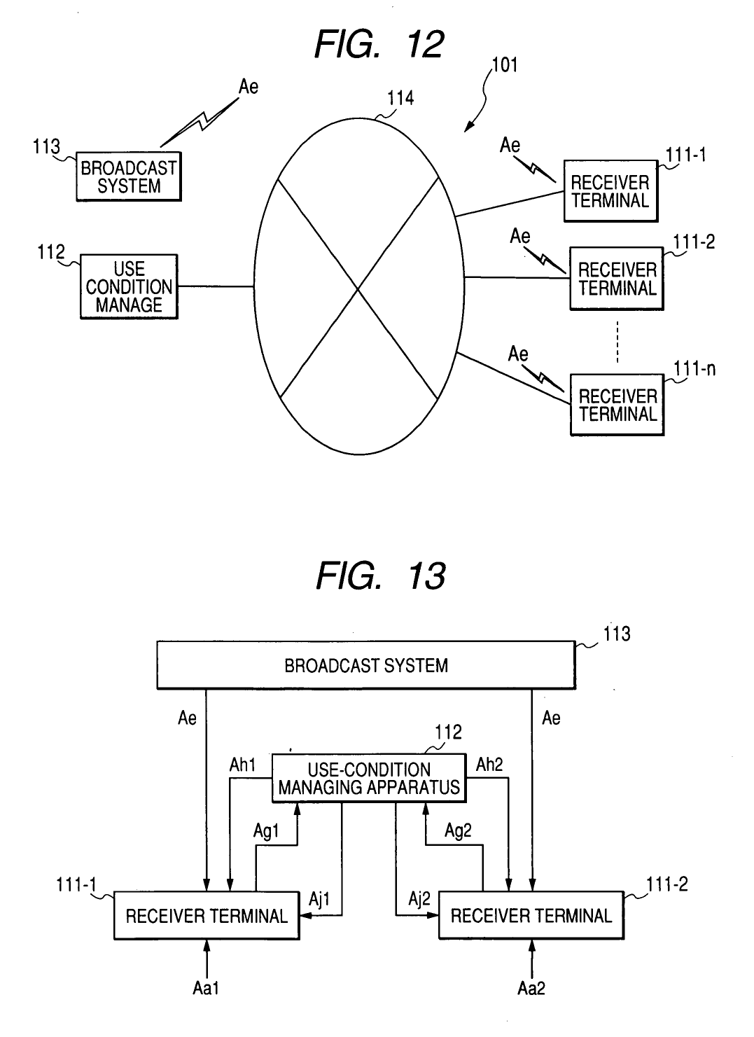

FIG. 12 shows a contents-data broadcasting and receiving system (a contents-data using system) 101 according to a seventh embodiment of this invention. The system 101 has broadcasting-side apparatuses and receiving-side apparatuses. The receiving-side apparatuses are also called the user-side apparatuses.

The broadcasting-side apparatuses include a use-condition managing apparatus (a use-history-information managing apparatus) 112 and a broadcasting system 113 designed to broadcast multiplexed data Ae having contents data composed of different content data pieces, for example, different channel data pieces.

The user-side apparatuses include receiver terminals (data using apparatuses) 111-1, 111-2, . . . , 111-n each for receiving the broadcasted data Ae from the broadcasting system 113, selecting a desired one among the different content data pieces in the received data Ae, and reproducing a content represented by the selected content data piece or recording the selected content data piece.

The receiver terminals 111-1, 111-2, . . . , 111-n and the use-condition managing apparatus 112 are connected via the Internet 114. Therefore, the receiver terminals 111-1, 111-2, . . . , 111-n and the use-condition managing apparatus 112 can communicate with one another via the Internet 114.

Each of the receiver terminals 111-1, 111-2, . . . , 111-n has a first section for receiving the broadcasted data Ae, a second section for selecting desired one among the different content data pieces in the received data Ae in response to user's request, a third section for reproducing a content represented by the selected content data piece, and a fourth section for recording the selected content data piece. Furthermore, each of the receiver terminals 111-1, 111-2, . . . , 111-n has a fifth section for generating a content-data-use-history information piece each time the second section thereof selects a desired content data piece from the received data Ae and then the selected content data piece is used by the third section or the fourth section thereof. The use of the selected content data piece by the third section means reproducing a content represented by the selected content data piece. The use of the selected content data piece by the fourth section means recording the selected content data piece. In addition, each of the receiver terminals 111-1, 111-2, . . . , 111-n has a sixth section for recording the generated content-data-use-history information piece, and a seventh section for sending the generated content-data-use-history information piece to the use-condition managing apparatus 112 via the Internet 114. Furthermore, each of the receiver terminals 111-1, 111-2, . . . , 111-n has an eighth section for allowing a user to input a user ID (a user identification information piece) into the receiver terminal, a ninth section for authenticating the inputted user ID, and a tenth section for controlling the first section in response to the result of the authentication.

The use-condition managing apparatus 112 has a first section for receiving content-data-use-history information pieces from the respective receiver terminals 111-1, 111-2, . . . , 111-n via the Internet 114, and a second section for managing the received content-data-use-history information pieces on a centralization or unification basis. Furthermore, the use-condition managing apparatus 112 has a third section for deciding whether or not one user make at least two of the receiver terminals 111-1, 111-2, . . . , 111-n use a content data piece (or content data pieces) during respective terms at least partially overlapping each other. In addition, the use-condition managing apparatus 112 has a fourth section for, when the third section decides that one user make at least two of the receiver terminals 111-1, 111-2, . . . , 111-n use a content data piece (or content data pieces) during respective terms at least partially overlapping each other, prohibiting the at least two receiver terminals from using a content data piece (or content data pieces).

With reference to FIG. 13, the broadcasting system 113 broadcasts the multiplexed data Ae on a radio-wave, wireless, or wired transmission basis.

Different IDs (different user identification information pieces) are assigned to users, respectively. When using the receiver terminal 111-1, a first user is required to input a related user ID Aa1 thereinto. When using the receiver terminal 111-2, a second user is required to input a related user ID Aa2 thereinto. The receiver terminal 111-1 authenticates the inputted user ID Aa1. When the result of the authentication indicates that the inputted user ID Aa1 is legitimate, the receiver terminal 111-1 enables its receiving section (its first section) to receive the broadcasted data Ae. Otherwise, the receiver terminal 111-1 disables its receiving section. Similarly, the receiver terminal 111-2 authenticates the inputted user ID Aa2. When the result of the authentication indicates that the inputted user ID Aa2 is legitimate, the receiver terminal 111-2 enables its receiving section (its first section) to receive the broadcasted data Ae. Otherwise, the receiver terminal 111-2 disables its receiving section.

While each of the receiver terminals 111-1 and 111-2 receives the broadcasted data Ae, the user can control the receiver terminal in accordance with user's request to select desired one from the different content data pieces in the received data Ae. The user can use the selected content data piece through the third section or the fourth section of the receiver terminal. The use of the selected content data piece through the third section means reproducing a content represented by the selected content data piece. The use of the selected content data piece through the fourth section means recording the selected content data piece.

The receiver terminals 111-1 and 111-2 generate user history information pieces Ag1 and Ag2, respectively. For each selected content data piece, the receiver terminal 111-1 detects the starting time and the ending time of the use of the selected content data piece. The receiver terminal 111-1 may calculate the content-data use term between the detected starting time and the detected ending time. The receiver terminal 111-1 describes the starting time and the ending time of the use of the selected content data piece or the calculated content-data use term in the user history information piece Ag1 as a content-data use history record related with the user ID Aa1. Since the content-data use term is defined by the starting time and the ending time of the use of the selected content data piece, the content-data use term is indirectly or directly represented by the content-data use history record related with the user ID Aa1. The user history information piece Ag1 is updated each time a selected content data piece is used in the receiver terminal 111-1. Similarly, for each selected content data piece, the receiver terminal 111-2 detects the starting time and the ending time of the use of the selected content data piece. The receiver terminal 111-2 may calculate the content-data use term between the detected starting time and the detected ending time. The receiver terminal 111-2 describes the starting time and the ending time of the use of the selected content data piece or the calculated content-data use term in the user history information piece Ag2 as a content-data use history record related with the user ID Aa2. Since the content-data use term is defined by the starting time and the ending time of the use of the selected content data piece, the content-data use term is indirectly or directly represented by the content-data use history record related with the user ID Aa2. The user history information piece Ag2 is updated each time a selected content data piece is used in the receiver terminal 111-2.

The receiver terminal 111-1 repetitively sends the user history information piece Ag1 to the use-condition managing apparatus 112 at preset regular time intervals. Alternatively, the receiver terminal 111-1 may respond to a history requirement signal Ah1 transmitted from the use-condition managing apparatus 112. In this case, the receiver terminal 111-1 sends the user history information piece Ag1 to the use-condition managing apparatus 112 in response to the history requirement signal Ah1. The history requirement signal Ah1 is transmitted from the use-condition managing apparatus 112 at an arbitrary moment. Alternatively, the history requirement signal Ah1 may be repetitively transmitted at prescribed regular time intervals.

The receiver terminal 111-2 repetitively sends the user history information piece Ag2 to the use-condition managing apparatus 112 at preset regular time intervals. Alternatively, the receiver terminal 111-2 may respond to a history requirement signal Ah2 transmitted from the use-condition managing apparatus 112. In this case, the receiver terminal 111-2 sends the user history information piece Ag2 to the use-condition managing apparatus 112 in response to the history requirement signal Ah2. The history requirement signal Ah2 is transmitted from the use-condition managing apparatus 112 at an arbitrary moment. Alternatively, the history requirement signal Ah2 may be repetitively transmitted at prescribed regular time intervals.

The use-condition managing apparatus 112 receives the user history information pieces Ag1 and Ag2 from the receiver terminals 111-1 and 111-2 respectively. The use-condition managing apparatus 112 compares the content-data use history records in the received user history information pieces Ag1 and Ag2, and thereby decides whether or not at least two of content-data use terms described therein and related with a same user ID at least partially overlap each other. When it is decided that at least two content-data use terms overlap each other, the use-condition managing apparatus 112 generates user-ID-dependent multiple use notices (user-ID-dependent duplicate use notices) Aj1 and Aj2 inclusive of and related with the same user ID. Specifically, the use-condition managing apparatus 12 designates the same user ID as a specified user ID (an illegal user ID), and places the specified user ID in the user-ID-dependent multiple use notices Aj1 and Aj2. On the other hand, when it is not decided that at least two content-data use terms overlap each other, the use-condition managing apparatus 112 does not generate the user-ID-dependent multiple use notices Aj1 and Aj2. The use-condition managing apparatus 112 sends the user-ID-dependent multiple use notices Aj1 and Aj2 to the receiver terminals 111-1 and 111-2 respectively. It should be noted that the user-ID-dependent multiple use notices Aj1 and Aj2 may be the same.

For example, in the case where users input the same user ID Aa1 into the receiver terminals 111-1 and 111-2 and operate the receiver terminals 111-1 and 111-2 to use a desired content date piece or desired content data pieces during terms at least partially overlapping each other, the use-condition managing apparatus 112 generates user-ID-dependent multiple use notices Aj1 and Aj2 and sends them to the receiver terminals 111-1 and 111-2 respectively.

The receiver terminal 111-1 prohibits the use of content data pieces in response to the user-ID-dependent multiple use notice Aj1 sent from the use-condition managing apparatus 112. Similarly, the receiver terminal 111-2 prohibits the use of content data pieces in response to the user-ID-dependent multiple use notice Aj2 sent from the use-condition managing apparatus 112.

As previously mentioned, in the contents-data broadcasting and receiving system 101, the receiver terminals 111-1, 111-2, . . . , 111-n receive the multiplexed data Ae from the broadcasting system 113. The receiver terminals 111-1, 111-2, . . . , 111-n can use content data pieces in the received data Ae. The receiver terminals 111-1, 111-2, . . . , 111-n feed the use-condition managing apparatus 112 with user history information pieces representing conditions of the use of the content data pieces which are related with user IDs. The use-condition managing apparatus 112 refers to the user history information pieces, and thereby decides whether or not at least two of the receiver terminals 111-1, 111-2, . . . , 111-n which have authenticated a same user ID use a desired content date piece or desired content data pieces during terms at least partially overlapping each other. When at least two of the receiver terminals 111-1, 111-2, . . . , 111-n which have authenticated a same user ID use a desired content date piece or desired content data pieces during terms at least partially overlapping each other, the use-condition managing apparatus 112 sends the user-ID-dependent multiple use notices to the at least two receiver terminals. The at least two receiver terminals prohibit the use of content data pieces in response to the user-ID-dependent multiple use notices. Therefore, it is possible to prevent illegal use of content data pieces by at least two of the receiver terminals 111-1, 111-2, . . . , 111-n.

The receiver terminals 111-1, 111-2, . . . , 111-n are equal in structure and operation. Thus, only the receiver terminal 111-1 will be described in more detail.

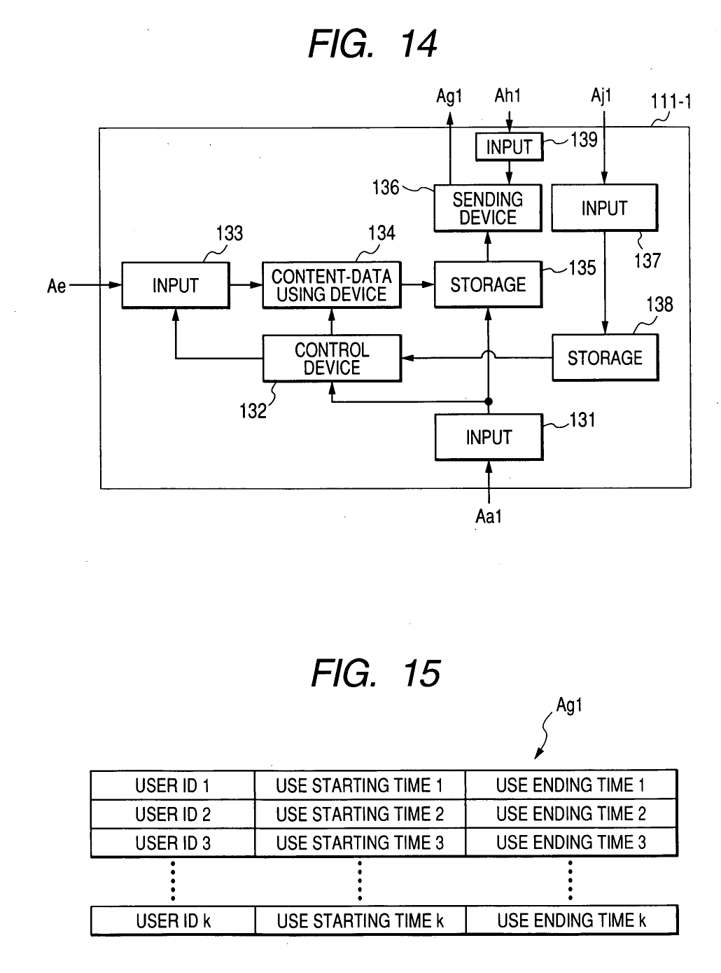

As shown in FIG. 14, the receiver terminal 111-1 includes an input device 131, a control device 132, an input device 133, a content-data using device 134, a storage device 135, a sending device 136, an input device 137, a storage device 138, and an input device 139.

A first example of the input device 131 includes buttons and a memory. A user can operate the buttons to input a related user ID Aa1 into the input device 131. The memory stores the inputted user ID Aa1.

A second example of the input device 131 includes a recording-medium drive and a memory. When a recording medium storing a user ID Aa1 is placed in the recording-medium drive, the user ID Aa1 is read from the recording medium and is inputted into the input device 131. The memory stores the inputted user ID Aa1. The recording medium is, for example, a magnetic card.

The input device 131 feeds the user ID Aa1 to the control device 132 and the storage device 135. Under management by the broadcasting side, at least one of (1) information representing a predetermined user name, (2) information representing a password, and (3) information representing an individual ID number can be used as the user ID Aa1. In general, the information representing the individual ID number is recorded on an IC card or an IC tag.

The control device 132 authenticates the user ID Aa1. When the result of the authentication indicates that the user ID Aa1 is legitimate, the control device 132 enables the input device 133 to receive multiplexed data Ae from the broadcasting system 113 (see FIGS. 12 and 13). Otherwise, the control device 132 disables the input device 133 to block the reception of the broadcasted data Ae.

The input device 133 decodes the received data Ae into content data pieces (for example, different channel data pieces). The input device 133 has a section which can be operated by a user. The input device 133 selects one from the content data pieces in accordance with user's operation. The input device 133 feeds the selected content data piece to the content-data using device 134.

The content-data using device 134 has a section which can be operated by a user. The content-data using device 134 reproduces a content represented by the fed content data piece and records the fed content data piece in accordance with user's operation. The content-data using device 134 may either reproduce a content represented by the fed content data piece or record the fed content data piece in accordance with user's operation.

Before the content-data using device 134 uses the fed content data piece as mentioned above, the control device 132 searches the storage device 138 for a user-ID-dependent multiple use notice or notices. In the presence of a user-ID-dependent multiple use notice or notices, the control device 132 compares the user ID Aa1 stored in the input device 131 with an user ID or IDs (a specified user ID or IDs, that is, an illegal user ID or IDs) contained in and related with the user-ID-dependent multiple use notice or notices. When the result of the comparison indicates that the user ID Aa1 is the same as the user ID contained in and related with the user-ID-dependent multiple use notice or one of the user IDs contained in and related with the user-ID-dependent multiple use notices, the control device 132 prohibits the content-data using device 134 from using the fed content data piece. Otherwise, the control device 132 permits the content-data using device 134 to use the fed content data piece.

The content-data using device 134 is connected with a clock device (not shown). The content-data using device 134 may include the clock device. The content-data using device 134 measures or detects the starting time p1 of the use of the fed content data piece by referring to the clock device. The content-data using device 134 stores a signal representative of the starting time p1 of the content-data-piece use into the storage device 135. A memory or a recording device can be used as the storage device 135. As previously mentioned, the user ID Aa1 is fed from the input device 131 to the storage device 135. The user ID Aa1 and the signal representative of the starting time p1 of the content-data-piece use are stored in the storage device 135 while being related with each other to form the former part of a content-data use history record related with the user ID Aa1. The content-data using device 134 measures or detects the ending time q1 of the use of the fed content data piece by referring to the clock device. The content-data using device 134 stores a signal representative of the ending time q1 of the content-data-piece use into the storage device 135. Specifically, the signal representative of the ending time q1 of the content-data-piece use is stored in the storage device 135 while being related with the user ID Aa1 to form the later part of the content-data use history record related with the user ID Aa1. The completed content-data use history record related with the user ID Aa1 is described in a user history information piece Ag1 stored in the storage device 135.

Since the starting time p1 and the ending time q1 define the term of the use of the content data piece, the completed content-data use history record represents the term of the use of the content data piece which is related with the user ID Aa1. Preferably, the starting time p1 and the ending time q1 are expressed in year, month, day, hour, minute, and second.

As shown in FIG. 15, the user history information piece Ag1 is divided into row segments indicating content-data use history records related with different user IDs respectively. Each of the content-data use history records is composed of a related user ID, a signal representative of the starting time of content-data-piece use, and a signal representative of the ending time of the content-data-piece use. Each of the content-data use history records indicates that a content data piece has been used by the content-data using device 134 during the term (the content-data use term) between the starting time and the ending time under the positive result of the authentication of the related user ID.

The sending device 136 repetitively reads the user history information piece Ag1 from the storage device 135 at preset regular time intervals, and sends the user history information piece Ag1 to the use-condition managing apparatus 112 (see FIGS. 12 and 13). Alternatively, the sending device 136 may respond to a history requirement signal Ah1 transmitted from the use-condition managing apparatus 112 to the input device 139. In this case, upon the reception of the history requirement signal Ah1, the input device 139 controls the sending device 136 to send the user history information piece Ag1 from the storage device 135 to the use-condition managing apparatus 112. The history requirement signal Ah1 is transmitted from the use-condition managing apparatus 112 at an arbitrary moment. Alternatively, the history requirement signal Ah1 may be repetitively transmitted at prescribed regular time intervals.

Preferably, the sending device 136 sends the whole of the user history information piece Ag1 from the storage device 135 to the use-condition managing apparatus 112. Alternatively, the sending device 136 may send only a newly-added content-data use history record or records in the user history information piece Ag1 from the storage device 135 to the use-condition managing apparatus 112.

The input device 137 can receive a user-ID-dependent multiple use notice Aj1 from the use-condition managing apparatus 112. The input device 137 stores the received user-ID-dependent multiple use notice Aj1 into the storage device 138. A memory or a recording device can be used as the storage device 138. The user-ID-dependent multiple use notice Aj1 contains a user ID related with the multiple use.

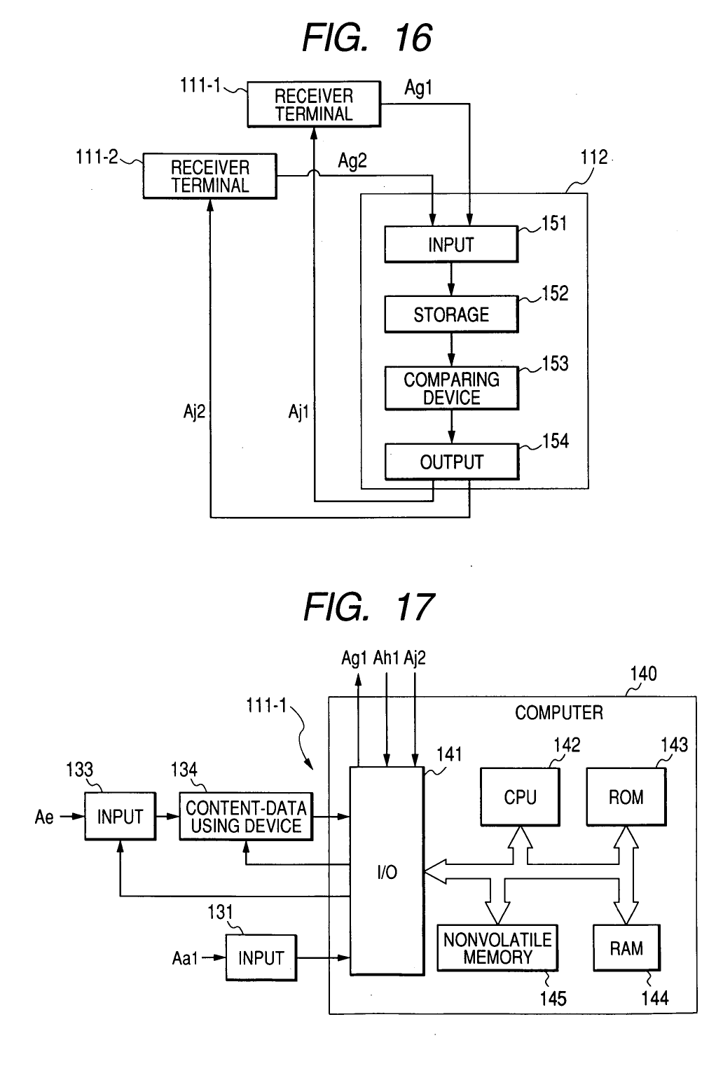

As shown in FIG. 16, the use-condition managing apparatus 112 includes an input device 151, a storage device 152, a comparing device 153, and an output device 154.

The input device 151 can receive user history information pieces Ag1 and Ag2 from the receiver terminals 111-1 and 111-2 respectively. The input device 151 stores the received user history information pieces Ag1 and Ag2 into the storage device 152. The input device 151 may update old user history information pieces Ag1 and Ag2 in the storage device 152 in accordance with the received user history information pieces Ag1 and Ag2. A memory or a recording device can be used as the storage device 152. Preferably, tables assigned to the respective receiver terminals 111-1 and 111-2 are provided in the storage device 152. The received user history information pieces Ag1 and Ag2 are placed in the related tables, respectively.

The comparing device 153 reads the user history information pieces Ag1 and Ag2 from the storage device 152, and compares the user history information pieces Ag1 and Ag2. Specifically, the comparing device 153 compares a user ID or IDs in a content-data use history record or records in the user history information piece Ag1 and a user ID or IDs in a content-data use history record or records in the user history information piece Ag2, and thereby finds a common user ID or IDs contained in both the user history information pieces Ag1 and Ag2. For the common user ID or each of the common user IDs, the comparing device 153 detects content-data use history records in the user history information pieces Ag1 and Ag2 which are related with the present common user ID. Then, the comparing device 153 calculates the first content-data use term between the starting time and the ending time represented by the detected content-data use history record in the user history information piece Ag1, and the second content-data use term between the starting time and the ending time represented by the detected content-data use history record in the user history information piece Ag2. Subsequently, the comparing device 153 decides whether or not the calculated first and second content-data use terms at least partially overlap each other. Finally, the comparing device 153 feeds the result of the decision to the output device 154. At this time, the comparing device 153 designates the present common user ID as a specified user ID (an illegal user ID) and adds the specified user ID to the decision result when the calculated first and second content-data use terms at least partially overlap each other. In the absence of a common user ID or IDs, the comparing device 153 notifies the absence to the output device 154 as the decision result.

When the decision result from the comparing device 153 indicates that the calculated first and second content-data use terms at least partially overlap each other, the output device 154 concludes that users input a same user ID into the receiver terminals 111-1 and 111-2 and use a content data piece or pieces during respective terms at least partially overlapping each other. In this case, the output device 154 extracts the common user ID (the specified user ID) from the decision result before generating user-ID-dependent multiple use notices Aj1 and Aj2 inclusive of the extracted user ID. The output device 154 sends the user-ID-dependent multiple use notices Aj1 and Aj2 to the receiver terminals 111-1 and 111-2 respectively. On the other hand, when the decision result from the comparing device 153 indicates the absence of a common user ID or IDs, or when the decision result does not indicate that the calculated first and second content-data use terms at least partially overlap each other, the output device 154 does not generate user-ID-dependent multiple use notices Aj1 and Aj2.

As previously described, the receiver terminals 111-1, 111-2, . . . , 111-n can receive the broadcasted data Ae from the broadcasting system 113. Each of the receiver terminals 111-1, 111-2, . . . , 111-n can select a desired content data piece from the received data Ae, and use the selected content data piece. The use-condition managing apparatus 112 can detect illegal conditions such that at least two of receiver terminals 111-1, 111-2, . . . , 111-n which have authenticated a same user ID use a desired content date piece or pieces during terms at least partially overlapping each other. Upon the detection of the illegal conditions, the use-condition managing apparatus 112 sends the user-ID-dependent multiple use notices to the at least two receiver terminals. The user-ID-dependent multiple use notices prohibit the at least two receiver terminals from using a content data piece or pieces. Thus, in the case where licenses are granted on an individual-by-individual basis, a plurality of persons can be prevented from illegally using one license.

It should be noted that each of the receiver terminals 111-1, 111-2, . . . , 111-n may be provided with a content data piece from a package medium such as a DVD, a CD-ROM, or a memory card. Alternatively, each of the receiver terminals 111-1, 111-2, . . . , 111-n may receive a content data piece from a contents server in a service provider via a communication network such as the Internet or a LAN.

The receiver terminal 111-1 may include the input device 131, the input device 133, the content-data using device 134, and a computer 140 as shown in FIG. 17. The computer 140 has a combination of an input/output (I/O) port 141, a CPU 142, a ROM 143, a RAM 144, and a nonvolatile memory 145. The computer 140 operates in accordance with a control program (a computer program) stored in the ROM 143, the RAM 144, or the nonvolatile memory 145.

The I/O port 141 can output control signals to the input device 133 and the content-data using device 134. The I/O port 141 can receive information from the content-data using device 134. The information indicates the starting time and the ending time of the use of a content data piece in the content-data using device 134. The I/O port 141 can receive a user ID Aa1 inputted via the input device 131. The I/O port 141 can receive a user-ID-dependent multiple use notice Aj1 and a history requirement signal Ah1 from the use-condition managing apparatus 112 (see FIGS. 12 and 13). The I/O port 141 can send a user history information piece Ag1 to the use-condition managing apparatus 112.

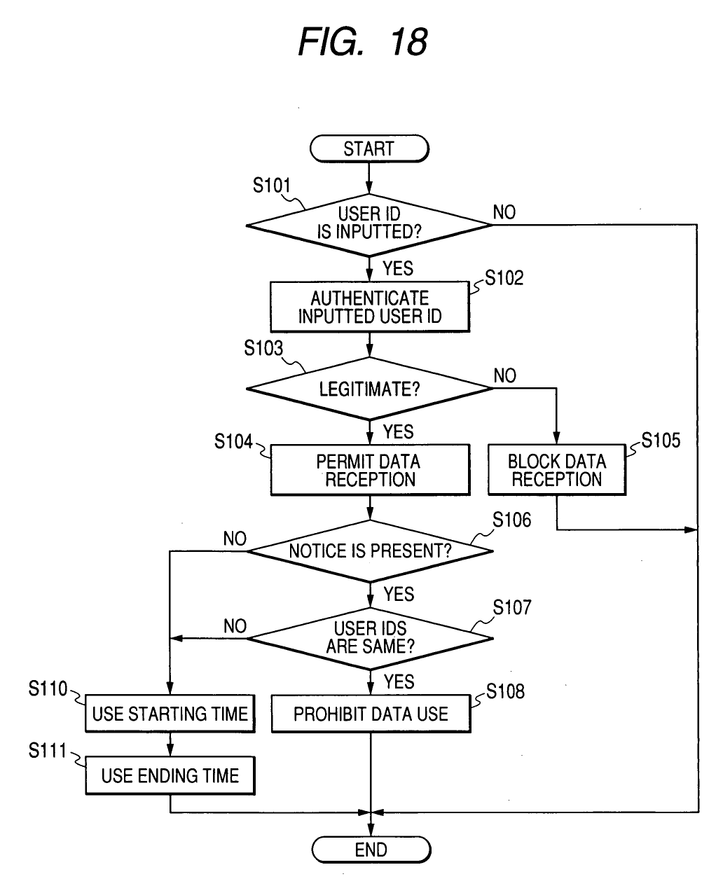

FIG. 18 is a flowchart of a first segment of the control program for the computer 140. The program segment in FIG. 18 is periodically iterated. As shown in FIG. 18, a first step S101 of the program segment decides whether or not a user ID Aa1 has just arrived at the I/O port 141. When a user ID Aa1 has just arrived, the program advances from the step S101 to a step S102. Otherwise, the program exits from the step S101 and then the current execution cycle of the program segment ends.

The step S102 authenticates the user ID Aa1. A step S103 following the step S102 decides whether or not the result of the authentication by the step S102 indicates that the user ID Aa1 is legitimate. When the authentication result indicates that the user ID Aa1 is legitimate, the program advances from the step S103 to a step S104. Otherwise, the program advances from the step S103 to a step S105.

The step S104 feeds an enabling control signal to the input device 133, thereby enabling the input device 133 to receive broadcasted data Ae.

The step S105 feeds a disabling control signal to the input device 133, thereby disabling the input device 133 and blocking the reception of the broadcasted data Ae. After the step S105, the current execution cycle of the program segment ends.

A step S106 following the step S104 decides whether or not at least one user-ID-dependent multiple use notice is present in the nonvolatile memory 145. When at least one user-ID-dependent multiple use notice is present, the program advances from the step S106 to a step S107. Otherwise, the program advances from the step S106 to a step S10.

The step S107 decides whether or not the user ID Aa1 and a user ID in the user-ID-dependent multiple use notice (one of user IDs in the user-ID-dependent multiple use notices) are the same. When the user ID Aa1 and the user ID in the user-ID-dependent multiple use notice are the same, the program advances from the step S107 to a step S108. Otherwise, the program advances from the step S107 to the step S110.

The step S108 feeds a use-prohibition control signal to the content-data using device 134, thereby prohibiting the content-data using device 134 from using a content data piece outputted by the input device 133. After the step S108, the current execution cycle of the program segment ends.

The step S110 refers to the information from the content-data using device 134, and thereby detects the starting time p1 of the use of a content data piece in the content-data using device 134. Then, the step S110 stores the user ID Aa1 and a signal representative of the starting time p1 of the content-data-piece use into the nonvolatile memory 145 while relating them with each other to form the former part of a content-data use history record related with the user ID Aa1.

A step S111 following the step S110 refers to the information from the content-data using device 134, and thereby detects the ending time q1 of the use of the content data piece by the content-data using device 134. Then, the step S110 stores a signal representative of the ending time q1 of the content-data-piece use into the nonvolatile memory 145 while relating the ending-time signal with the user ID Aa1 to form the later part of the content-data use history record related with the user ID Aa1. The completed content-data use history record related with the user ID Aa1 is described in a user history information piece Ag1 stored in the nonvolatile memory 145. After the step S111, the current execution cycle of the program segment ends.

According to a second segment of the control program, the computer 140 repetitively sends the user history information piece Ag1 from the nonvolatile memory 145 to the use-condition managing apparatus 112 at preset regular time intervals. Alternatively, the computer 140 may respond to a history requirement signal Ah1 from the use-condition managing apparatus 112. In this case, upon the reception of the history requirement signal Ah1, the computer 140 transfers the user history information piece Ag1 from the nonvolatile memory 145 to the use-condition managing apparatus 112.

According to a third segment of the control program, the computer 140 can receive a user-ID-dependent multiple use notice Aj1 from the use-condition managing apparatus 112. The computer 140 stores the received user-ID-dependent multiple use notice Aj1 into the nonvolatile memory 145.

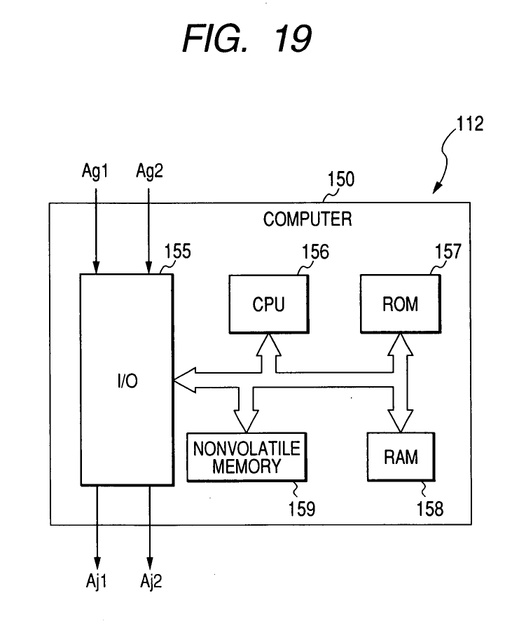

The use-condition managing apparatus 112 may include a computer 150 as shown in FIG. 19. The computer 150 has a combination of an input/output (I/O) port 155, a CPU 156, a ROM 157, a RAM 158, and a nonvolatile memory 159. The computer 150 operates in accordance with a control program (a computer program) stored in the ROM 157, the RAM 158, or the nonvolatile memory 159.

The I/O port 155 can receive user history information pieces Ag1, Ag2, . . . from the receiver terminals 111-1, 111-2, . . . , 111-n respectively. The I/O port 155 can send a user-ID-dependent multiple use notice (user-ID-dependent multiple use notices Aj1, Aj2, . . . ) to the receiver terminals 111-1, 111-2, . . . , 111-n.

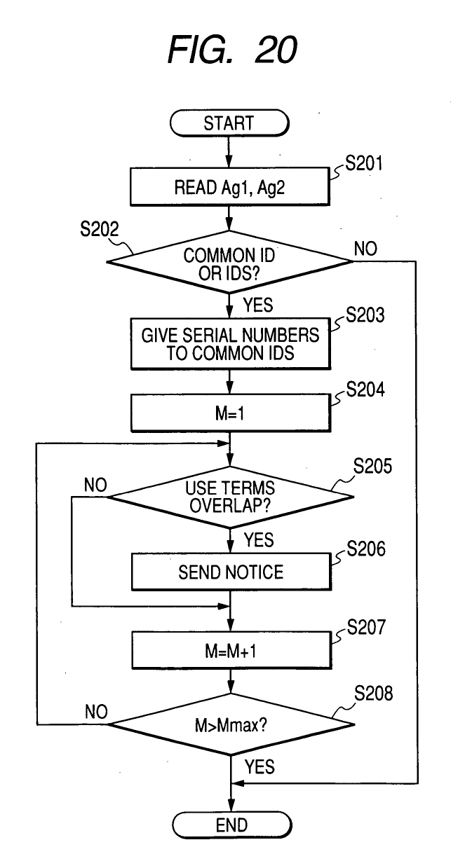

FIG. 20 is a flowchart of a first segment of the control program for the computer 150. The program segment in FIG. 20 is periodically iterated. As shown in FIG. 20, a first step S201 of the program segment reads user history information pieces from the nonvolatile memory 159.

A step S202 following the step S201 compares user IDs in content-data use history records in the user history information pieces, and thereby finds a common user ID or IDs. The step S202 decides whether or not at least one common user ID is present. When at least one common user ID is present, the program advances from the step S202 to a step S203. Otherwise, the program exits from the step S202 and then the current execution cycle of the program segment ends.

The step S203 gives serial numbers “1”, “2”, . . . , “Mmax” to the common user IDs (the common user ID) respectively.

A step S204 subsequent to the step S203 sets a variable M to “1”. After the step S204, the program advances to a step S205.

The step S205 detects content-data use history records in the user history information pieces which are related with a common user ID having a serial number equal to the value M. Then, the step S205 calculates the content-data use term between the starting time and the ending time represented by each of the detected content-data use history records. Subsequently, the step S205 decides whether or not the calculated content-data use terms at least partially overlap one another. When the calculated content-data use terms at least partially overlap one another, the program advances from the step S205 to a step S206. Otherwise, the program advances from the step S205 to a step S207.

The step S206 generates a user-ID-dependent multiple use notice (user-ID-dependent multiple use notices Aj1, Aj2 . . . ) inclusive of the common user ID having a serial number equal to the value M. Specifically, the step S206 designates the common user ID as a specified user ID (an illegal user ID), and places the specified user ID in the user-ID-dependent multiple use notice. The step S206 sends the user-ID-dependent multiple use notice to the receiver terminals 111-1, 111-2, . . . , 111-n. After the step S206, the program advances to the step S207.

The step S207 increments the value M by “1”. After the step S207, the program advances to a step S208.

The step S208 decides whether or not the value M is greater than the value Mmax. When the value M is greater than the value Mmax, the program exits from the step S208 and then the current execution cycle of the program segment ends. Otherwise, the program returns from the step S208 to the step S205.

According to a second segment of the control program, the computer 150 can receive user history information pieces Ag1, Ag2, . . . from the receiver terminals 111-1, 111-2, . . . , 111-n respectively. The computer 150 stores the received user history information pieces Ag1, Ag2, . . . into the nonvolatile memory 159. The computer 150 may update old user history information pieces Ag1, Ag2 . . . in the nonvolatile memory 159 in accordance with the received user history information pieces Ag1, Ag2 . . . .

### Eighth Embodiment

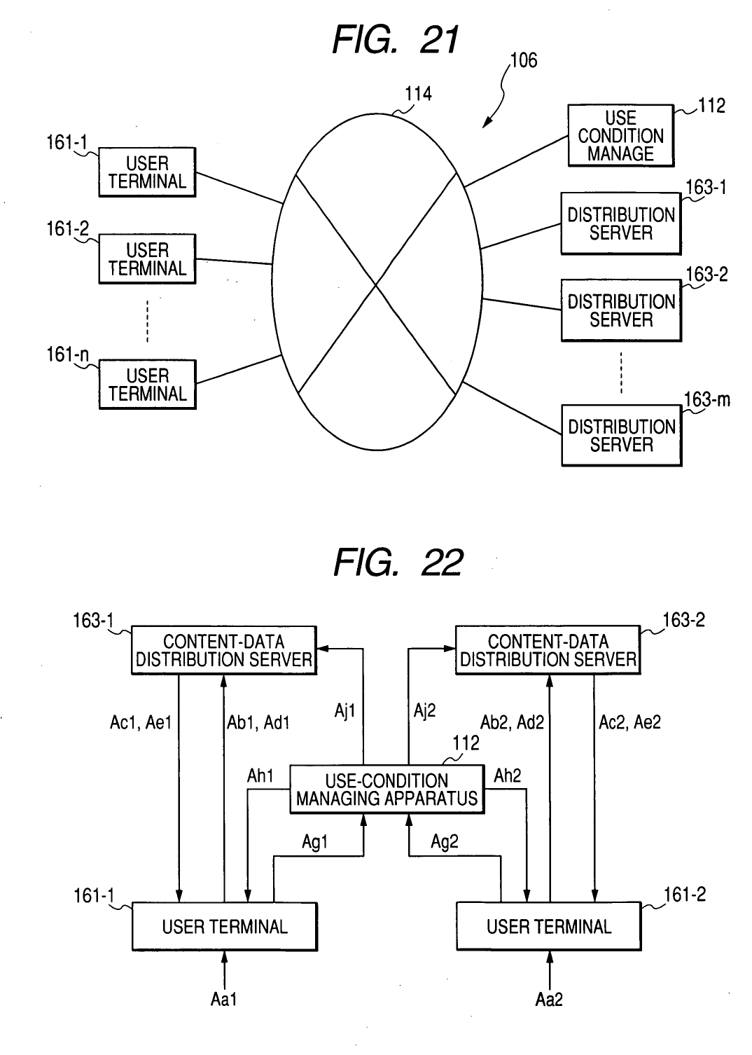

FIG. 21 shows a contents-data distribution system (a contents-data using system) 106 according to an eighth embodiment of this invention.

As shown in FIG. 21, the system 106 includes user terminals (data using apparatuses) 161-1, 161-2, . . . , 161-n, a use-condition managing apparatus (a use-history-information managing apparatus) 112, and content-data distribution servers (content-data distributing apparatuses) 163-1, 163-2, . . . , 163-m where “n” and “m” denote predetermined natural numbers equal to or different from each other. The user terminals 161-1, 161-2, . . . , 161-n, the use-condition managing apparatus 112, and the content-data distribution servers 163-1, 163-2, . . . , 163-m are connected via the Internet 114 so that they can communicate with one another. The user terminals 161-1, 161-2, . . . , 161 -n, the use-condition managing apparatus 112, and the content-data distribution servers 163-1, 163-2, . . . , 163-m have different addresses, respectively. The use-condition managing apparatus 112 is similar to that in the seventh embodiment of this invention. The use-condition managing apparatus 112 and the content-data distribution servers 163-1, 163-2, . . . , 163-m are located in a contents-data service provider. The content-data distribution servers 163-1, 163-2, . . . , 163-m are managed by the provider.

The user terminals 161-1, 161-2, . . . , 161-n include operation units respectively. Users can input user's requests into the user terminals 161-1, 161-2, . . . , 161-n by actuating the operation units. The user terminals 161-1, 161-2, . . . , 161-n further include displays respectively. Alternatively, the user terminals 161-1, 161-2, . . . , 161-n may be connected with displays respectively.

In the contents-data distribution system 106, each of the user terminals 161-1, 161-2, . . . , 161-n can send the provider a request to download a content data piece desired by a related user. In response to such a download request, one of the content-data distribution servers 163-1, 163-2, . . . , 163-m can send a desired content data piece to the requester, that is, the user terminal sending the download request. Thus, the desired content data piece can be downloaded into the requester. The downloaded content data piece can be used by the requester.

Each of the user terminals 161-1, 161-2, . . . , 161-n generates and records a content-data-use-history information piece each time a downloaded content data piece is used by the user terminal. The use of the downloaded content data piece means at least one of reproducing a content represented by the downloaded content data piece and copying the downloaded content data piece. The generated content-data-use-history information piece contains a user ID (a user identification information piece) for a user using the downloaded content data piece. Thus, the content-data-use-history information pieces generated by the user terminals 161-1, 161-2, . . . , 161-n can be sorted according to user. The user terminals 161-1, 161-2, . . . , 161-n send the content-data-use-history information pieces to the use-condition managing apparatus 112.

The use-condition managing apparatus 112 receives the content-data-use-history information pieces from the respective user terminals 161-1, 161-2, . . . , 161-n. The use-condition managing apparatus 112 manages the received content-data-use-history information pieces on a centralization or unification basis. Furthermore, the use-condition managing apparatus 112 decides whether or not one user make at least two of the user terminals 161-1, 161-2, . . . , 161-n use a content data piece (or content data pieces) during respective terms at least partially overlapping each other. When it is decided that one user make at least two of the user terminals 161-1, 161-2, . . . , 161-n use a content data piece (or content data pieces) during respective terms at least partially overlapping each other, the use-condition managing apparatus 112 sends a multiple use notice (a duplicate use notice) inclusive of a user ID for the user to the content-data distribution servers 163-1, 163-2, . . . , 163-m. The multiple use notice prohibits the at least two user terminals from using a content data piece (or content data pieces).

With reference to FIG. 22, different user IDs (different user identification information pieces) are assigned to users, respectively. When using the user terminal 161-1, a first user is required to input a related user ID Aa1 thereinto. When using the user terminal 161-2, a second user is required to input a related user ID Aa2 thereinto.

The user terminal 161-1 generates an authentication request signal Ab1 in response to the inputted user ID Aa1. The authentication request signal Ab1 contains the user ID Aa1. The user terminal 161-1 sends the authentication request signal Ab1 to the content-data distribution server 163-1. The user terminal 161-2 generates an authentication request signal Ab2 in response to the inputted user ID Aa2. The authentication request signal Ab2 contains the user ID Aa2. The user terminal 161-2 sends the authentication request signal Ab2 to the content-data distribution server 163-2.

Upon the reception of the authentication request signal Ab1, the content-data distribution server 163-1 implements authentication. Specifically, the content-data distribution server 163-1 decides whether or not the user ID Aa1 represented by the authentication request signal Ab1 is legitimate. When the user ID Aa1 is legitimate, the content-data distribution server 163-1 generates an authentication completion signal. Otherwise, the content-data distribution server 163-1 generates an error signal. Then, the content-data distribution server 163-1 sends the authentication completion signal or the error signal to the user terminal 161-1 as an authentication reply signal Ac1.

Upon the reception of the authentication request signal Ab2, the content-data distribution server 163-2 implements authentication. Specifically, the content-data distribution server 163-2 decides whether or not the user ID Aa2 represented by the authentication request signal Ab2 is legitimate. When the user ID Aa2 is legitimate, the content-data distribution server 163-2 generates an authentication completion signal. Otherwise, the content-data distribution server 163-2 generates an error signal. Then, the content-data distribution server 163-2 sends the authentication completion signal or the error signal to the user terminal 161-2 as an authentication reply signal Ac2.

The user terminal 161-1 receives the authentication reply signal Ac1. The user terminal 161-1 decides whether the received authentication reply signal Ac1 is an authentication completion signal or an error signal. When the authentication reply signal Ac1 is an authentication completion signal, the user terminal 161-1 indicates a first prescribed message on the related display. The first prescribed message is designed to urge the user to input or designate the name of a desired content. When the user inputs or designates the name of the desired content, the user terminal 161-1 identifies a content data piece having the desired content. The user terminal 161-1 generates a content request signal Ad1 corresponding to the identified content data piece. The user terminal 161-1 adds its address (requester's address) and the user ID Aa1 to the content request signal Ad1. The user terminal 161-1 sends the resultant content request signal Ad1 to the content-data distribution server 163-1. On the other hand, when the authentication reply signal Ac1 is an error signal, the user terminal 161-1 indicates a second prescribed message on the related display. The second prescribed message is designed to urge the user to input the user ID Aa1 again.

The user terminal 161-2 receives the authentication reply signal Ac2. The user terminal 161-2 decides whether the received authentication reply signal Ac2 is an authentication completion signal or an error signal. When the authentication reply signal Ac2 is an authentication completion signal, the user terminal 161-2 indicates a first prescribed message on the related display. The first prescribed message is designed to urge the user to input or designate the name of a desired content. When the user inputs or designates the name of the desired content, the user terminal 161-2 identifies a content data piece having the desired content. The user terminal 161-2 generates a content request signal Ad2 corresponding to the identified content data piece. The user terminal 161-2 adds its address (requester's address) and the user ID Aa2 to the content request signal Ad2. The user terminal 161-2 sends the resultant content request signal Ad2 to the content-data distribution server 163-2. On the other hand, when the authentication reply signal Ac2 is an error signal, the user terminal 161-2 indicates a second prescribed message on the related display. The second prescribed message is designed to urge the user to input the user ID Aa2 again.

The content-data distribution server 163-1 receives the content request signal Ad1. The content-data distribution server 163-1 retrieves the desired content data piece Ae1 from its database in response to the received content request signal Ad1. The content-data distribution server 163-1 sends the desired content data piece Ae1 to the user terminal 161-1.

The content-data distribution server 163-2 receives the content request signal Ad2. The content-data distribution server 163-2 retrieves the desired content data piece Ae2 from its database in response to the received content request signal Ad2. The content-data distribution server 163-2 sends the desired content data piece Ae2 to the user terminal 161-2.

In the contents-data distribution system 106, the desired content data pieces Ae1 and Ae2 are downloaded from the content-data distribution servers 163-1 and 163-2 into the user terminals 161-1 and 161-2 provided that the user IDs Aa1 and Aa2 inputted into the user terminals 161-1 and 161-2 are legitimate.

The user can use the desired content data piece Ae1 through the user terminal 161-1. The use of the desired content data piece Ae1 means at least one of reproducing a content represented by the content data piece Ae1 and copying the content data piece Ae1. Similarly, the user can use the desired content data piece Ae2 through the user terminal 161-2. The use of the desired content data piece Ae2 means at least one of reproducing a content represented by the content data piece Ae2 and copying the content data piece Ae2.

The user terminals 161-1 and 161-2 generate user history information pieces Ag1 and Ag2, respectively. The user terminal 161-1 detects the starting time and the ending time of the use of the desired content data piece Ae1. The user terminal 161-1 may calculate the content-data use term between the detected starting time and the detected ending time. The user terminal 161-1 describes the starting time and the ending time of the use of the desired content data piece Ae1 or the calculated content-data use term in the user history information piece Ag1 as a content-data use history record related with the user ID Aa1. Since the content-data use term is defined between the starting time and the ending time of the use of the desired content data piece Ae1, the content-data use term is indirectly or directly represented by the content-data use history record related with the user ID Aa1. The user history information piece Ag1 is updated each time a desired content data piece is used in the user terminal 161-1. Similarly, the user terminal 161-2 detects the starting time and the ending time of the use of the desired content data piece Ae2. The user terminal 161-2 may calculate the content-data use term between the detected starting time and the detected ending time. The user terminal 161-2 describes the starting time and the ending time of the use of the desired content data piece Ae2 or the calculated content-data use term in the user history information piece Ag2 as a content-data use history record related with the user ID Aa2. Since the content-data use term is defined between the starting time and the ending time of the use of the desired content data piece Ae2, the content-data use term is indirectly or directly represented by the content-data use history record related with the user ID Aa2. The user history information piece Ag2 is updated each time a desired content data piece is used in the user terminal 161-2.

The user terminal 161-1 repetitively sends the user history information piece Ag1 to the use-condition managing apparatus 112 at preset regular time intervals. Alternatively, the user terminal 161-1 may respond to a history requirement signal Ah1 transmitted from the use-condition managing apparatus 112. In this case, the user terminal 161-1 sends the user history information piece Ag1 to the use-condition managing apparatus 112 in response to the history requirement signal Ah1. The history requirement signal Ah1 is transmitted from the use-condition managing apparatus 112 at an arbitrary moment. Alternatively, the history requirement signal Ah1 may be repetitively transmitted at prescribed regular time intervals.

The user terminal 161-2 repetitively sends the user history information piece Ag2 to the use-condition managing apparatus 112 at preset regular time intervals. Alternatively, the user terminal 161-2 may respond to a history requirement signal Ah2 transmitted from the use-condition managing apparatus 112. In this case, the user terminal 161-2 sends the user history information piece Ag2 to the use-condition managing apparatus 112 in response to the history requirement signal Ah2. The history requirement signal Ah2 is transmitted from the use-condition managing apparatus 112 at an arbitrary moment. Alternatively, the history requirement signal Ah2 may be repetitively transmitted at prescribed regular time intervals.

The use-condition managing apparatus 112 receives the user history information pieces Ag1 and Ag2 from the user terminals 161-1 and 161-2 respectively. The use-condition managing apparatus 112 compares the content-data use history records in the received user history information pieces Ag1 and Ag2, and thereby decides whether or not at least two of content-data use terms described therein and related with a same user ID at least partially overlap each other. When it is decided that at least two content-data use terms overlap each other, the use-condition managing apparatus 112 generates user-ID-dependent multiple use notices (user-ID-dependent duplicate use notices) Aj1 and Aj2 inclusive of the same user ID. Specifically, the use-condition managing apparatus 112 designates the same user ID as a specified user ID (an illegal user ID), and places the specified user ID in the user-ID-dependent multiple use notices Aj1 and Aj2. On the other hand, when it is not decided that at least two content-data use terms overlap each other, the use-condition managing apparatus 112 does not generate the user-ID-dependent multiple use notices Aj1 and Aj2. The use-condition managing apparatus 112 sends the generated user-ID-dependent multiple use notices Aj1 and Aj2 to the content-data distribution servers 163-1 and 163-2 respectively. It should be noted that the user-ID-dependent multiple use notices Aj1 and Aj2 may be the same.

For example, in the case where users input the same user ID Aa1 into the user terminals 161-1 and 161-2 and pass the authentication before operating the user terminals 161-1 and 161-2 to download the desired content date pieces Ae1 and Ae2 and then use them during terms at least partially overlapping each other, the use-condition managing apparatus 112 generates user-ID-dependent multiple use notices Aj1 and Aj2 inclusive of the user ID Aa1 and sends them to the content-data distribution servers 163-1 and 163-2 respectively.

Upon the reception of the user-ID-dependent multiple use notice Aj1, the content-data distribution server 163-1 controls the user terminal 161-1 to prohibit the use of the desired content data piece Ae1 therein. Similarly, upon the reception of the user-ID-dependent multiple use notice Aj2, the content-data distribution server 163-2 controls the user terminal 161-2 to prohibit the use of the desired content data piece Ae2 therein.

As previously mentioned, in the contents-data distribution system 106, the user terminals 161-1, 161-2, . . . , 161-n can receive the content data pieces Ae1, Ae2, . . . from the content-data distribution serves 163-1, 163-2, . . . , 163-m. The content data pieces Ae1, Ae2, can be used in the user terminals 161-1, 161-2, . . . , 161-n, respectively. The user terminals 161-1, 161-2, . . . , 161-n feed the use-condition managing apparatus 112 with user history information pieces representing conditions of the use of the content data pieces which are related with user IDs. The use-condition managing apparatus 112 refers to the fed user history information pieces, and thereby decides whether or not at least two of the user terminals 161-1, 161-2, . . . , 161-n which have a same authenticated user ID use desired content data pieces during terms at least partially overlapping each other. When at least two of the user terminals 161-1, 161-2, . . . , 161-n which have a same authenticated user ID use desired content data pieces during terms at least partially overlapping each other, the use-condition managing apparatus 112 sends user-ID-dependent multiple use notices inclusive of the same user ID to the content-data distribution servers 163-1, 163-2, . . . , 163-m. Upon the reception of the user-ID-dependent multiple use notices, the content-data distribution servers 163-1, 163-2, . . . , 163-m control the at least two user terminals in question to prohibit the use of the content data pieces therein. Therefore, it is possible to prevent the illegal use of content data pieces in the user terminals 161-1, 161-2, . . . , 161-n.

The user terminals 161-1, 161-2, . . . , 161-n are equal in structure and operation. Thus, only the user terminal 161-1 will be described in more detail. The user terminal 161-1 is similar to the receiver terminal 111-1 (see FIG. 14) except for design changes mentioned hereafter.

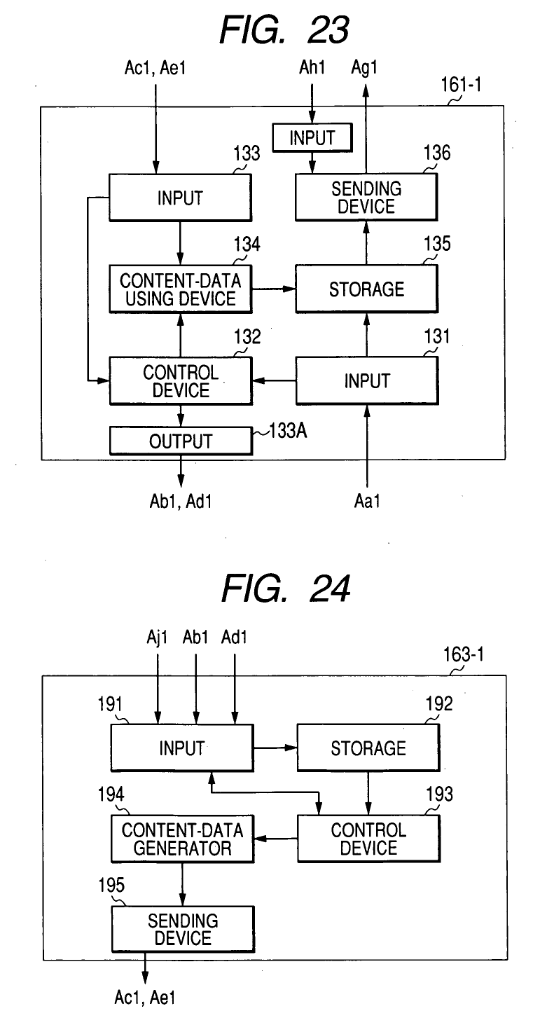

As shown in FIG. 23, the user terminal 161-1 includes an input device 131, a control device 132, an input device 133, an output device 133A, a content-data using device 134, a storage device 135, a sending device 136, and an input device 139.

A first example of the input device 131 includes buttons and a memory. A user can operate the buttons to input a user ID Aa1 into the input device 131. The memory stores the inputted user ID Aa1.

A second example of the input device 131 includes a recording-medium drive and a memory. When a recording medium storing a user ID Aa1 is placed in the recording-medium drive, the user ID Aa1 is read from the recording medium and is inputted into the input device 131. The memory stores the inputted user ID Aa1. The recording medium is, for example, a magnetic card.

The input device 131 feeds the user ID Aa1 to the control device 132 and the storage device 135. Under management by the contents-data service provider side, at least one of (1) information representing a predetermined user name, (2) information representing a password, and (3) information representing an individual ID number can be used as the user ID Aa1. In general, the information representing the individual ID number is recorded on an IC card or an IC tag.

The control device 132 generates an authentication request signal Ab1 in response to the user ID Aa1. The authentication request signal Ab1 contains the user ID Aa1. The control device 132 feeds the authentication request signal Ab1 to the output device 133A. The control device 132 controls the output device 133A to send the authentication request signal Ab1 to the content-data distribution server 163-1. Preferably, the authentication request signal Ab1 has encrypted information. The authentication request signal Ab1 may be the encrypted version or the non-encrypted version of the user ID Aa1.

The input device 133 can receive an authentication reply signal Ac1 from the content-data distribution server 163-1. The input device 133 feeds the received authentication reply signal Ac1 to the control device 132. The control device 132 decides whether the authentication reply signal Ac1 is an authentication completion signal or an error signal. When the authentication reply signal Ac1 is an authentication completion signal, the control device 132 controls and drives the related display to indicate a first prescribed message designed to urge the user to input or designate the name of a desired content. As the user inputs or designates the name of the desired content, the control device 132 is informed of the desired-content name. According to the desired-content name, the control device 132 identifies a content data piece having the desired content. The control device 132 generates a content request signal Ad1 corresponding to the identified content data piece. The control device 132 adds the address of the user terminal 161-1 (requester's address) and the user ID Aa1. The control device 132 feeds the resultant content request signal Ad1 to the output device 133A. The control device 132 controls the output device 133A to send the content request signal Ad1 to the content-data distribution server 163-1. On the other hand, when the authentication reply signal Ac1 is an error signal, the control device 132 controls and drives the related display to indicate a second prescribed message designed to urge the user to input the user ID Aa1 again.

The input device 133 can receive the desired content data piece Ae1 from the content-data distribution server 163-1. It should be noted that the desired content data piece Ae1 is sent from the content-data distribution server 163-1 in response to the content request signal Ad1. The input device 133 feeds the desired content data piece Ae1 to the content-data using device 134.

The desired content data piece Ae1 has main data components and content-use prohibiting information. The control device 132 accesses the desired content data piece Ae1 in the content-data using device 134. The control device 132 analyzes the content-use prohibiting information in the desired content data piece Ae1. The control device 132 controls the content-data using device 134 in response to the result of the analyzation to selectively allow and prohibit the use of the desired content data piece Ae1 therein. Specifically, the control device 132 decides whether the content-use prohibiting information is in its active state or its inactive state. When the content-use prohibiting information is in its active state, the control device 132 prohibits the content-data using device 134 from using the desired content data piece Ae1. On the other hand, when the content-use prohibiting information is in its inactive state, the control device 132 permits the content-data using device 134 to use the desired content data piece Ae1.

The content-data using device 134 is connected with a clock device (not shown). The content-data using device 134 may include the clock device. The content-data using device 134 measures or detects the starting time p1 of the use of the desired content data piece Ae1 by referring to the clock device. The content-data using device 134 stores a signal representative of the starting time p1 of the content-data-piece use into the storage device 135. As previously mentioned, the user ID Aa1 is fed from the input device 131 to the storage device 135. The user ID Aa1 and the signal representative of the starting time p1 of the content-data-piece use are stored in the storage device 135 while being related with each other to form the former part of a content-data use history record related with the user ID Aa1. The content-data using device 134 measures or detects the ending time q1 of the use of the desired content data piece Ae1 by referring to the clock device. The content-data using device 134 stores a signal representative of the ending time q1 of the content-data-piece use into the storage device 135. Specifically, the signal representative of the ending time q1 of the content-data-piece use is stored in the storage device 135 while being related with the user ID Aa1 to form the later part of the content-data use history record related with the user ID Aa1. The completed content-data use history record related with the user ID Aa1 is described in a user history information piece Ag1 stored in the storage device 135.

Sine the starting time p1 and the ending time q1 define the term of the use of the content data piece Ae1, the completed content-data use history record represents the term of the use of the content data piece Ae1 which is related with the user ID Aa1. Preferably, the starting time p1 and the ending time q1 are expressed in year, month, day, hour, minute, and second. The structure of the user history information piece Ag1 is the same as that in FIG. 15.

The sending device 136 repetitively reads the user history information piece Ag1 from the storage device 135 at preset regular time intervals, and sends the user history information piece Ag1 to the use-condition managing apparatus 112. Alternatively, the sending device 136 may respond to a history requirement signal Ah1 transmitted from the use-condition managing apparatus 112 to the input device 139. In this case, upon the reception of the history requirement signal Ah1, the input device 139 controls the sending device 136 to send the user history information piece Ag1 from the storage device 135 to the use-condition managing apparatus 112. The history requirement signal Ah1 is transmitted from the use-condition managing apparatus 112 at an arbitrary moment. Alternatively, the history requirement signal Ah1 may be repetitively transmitted at prescribed regular time intervals.

Preferably, the sending device 136 sends the whole of the user history information piece Ag1 from the storage device 135 to the use-condition managing apparatus 112. Alternatively, the sending device 136 may send only a newly-added content-data use history record or records in the user history information piece Ag1 from the storage device 135 to the use-condition managing apparatus 112.

The content-data distribution servers 163-1, 163-2, . . . , 163-m are equal in structure and operation. Thus, only the content-data distribution server 163-1 will be described in more detail.

As shown in FIG. 24, the content-data distribution server 163-1 includes an input device 191, a storage device 192, a control device 193, a content-data generator 194, and a sending device 195.

The input device 191 can receive an authentication request signal Ab1 from the user terminal 161-1. The input device 191 feeds the received authentication request signal Ab1 to the control device 193. The control device 193 implements authentication. Specifically, the control device 193 decides whether or not the user ID Aa1 represented by the authentication request signal Ab1 is legitimate. When the user ID Aa1 is legitimate, the control device 193 generates an authentication completion signal. Otherwise, the control device 193 generates an error signal. Then, the control device 193 feeds the authentication completion signal or the error signal to the sending device 195. The control device 193 controls the sending device 195 to send the authentication completion signal or the error signal to the user terminal 161-1 as an authentication reply signal Ac1.

The input device 191 can receive a content request signal Ad1 from the user terminal 161-1. The input device 191 feeds the received content request signal Ad1 to the control device 193. The control device 193 passes the content request signal Ad1 to the content-data generator 194.

The input device 191 can receive a user-ID-dependent multiple use notice Aj1 from the use-condition managing apparatus 112. The input device 191 extracts a user ID (a specified user ID or IDs, that is, an illegal user ID or IDs) from the received notice Aj1 before storing the extracted user ID into the storage device 192. The user ID in the storage device 192 relates to the multiple use. A memory or a recording device can be used as the storage device 192.

The control device 193 extracts a user ID from the content request signal Ad1. The control device 193 reads a user ID or IDs (a specified user ID or IDs, that is, an illegal user ID or IDs) from the storage device 192. The control device decides whether or not the extracted user ID is the same as one of the read user IDs (the read user ID). The control device 193 generates content-use prohibiting information in response to the result of the decision. The generated content-use prohibiting information is designed to prohibit the use of a content data piece in relation to the read user ID or IDs. When the extracted user ID is the same as one of the read user IDs (the read user ID), the content-use prohibiting information is in an active state. Otherwise, the content-use prohibiting information is in an inactive state. The control device 193 feeds the content-use prohibiting information to the content-data generator 194.

The content-data generator 194 retrieves the desired content data piece Ae1 from its database in response to the received content request signal Ad1. The content-data generator 194 adds the content-use prohibiting information to the desired content data piece Ae1. The content-data generator 194 feeds the resultant desired content data piece Ae1 to the sending device 195. The control device 193 extracts requester's address from the content request signal Ad1. The control device 193 controls the sending device 195 in response to the extracted requester's address to send the desired content data piece Ae1 to the user terminal 161-1, that is, the requester.

As previously described, the user terminals 161-1, 161-2, . . . , 161-n can receive content data pieces Ae1, Ae2, . . . from the content-data distribution serves 163-1, 163-2, . . . , 163-m. The content data pieces Ae1, Ae2, . . . can be used in the user terminals 161-1, 161-2, . . . , 161-n, respectively. The user terminals 161-1, 161-2, . . . , 161-n feed the use-condition managing apparatus 112 with user history information pieces representing conditions of the use of the content data pieces which are related with user IDs. The use-condition managing apparatus 112 refers to the fed user history information pieces, and thereby decides whether or not at least two of the user terminals 161-1, 161-2, . . . , 161-n which have a same authenticated user ID use desired content data pieces during terms at least partially overlapping each other. When at least two of the user terminals 161-1, 161-2, . . . , 161-n which have a same authenticated user ID use desired content data pieces during terms at least partially overlapping each other, the use-condition managing apparatus 112 sends the user-ID-dependent multiple use notices inclusive of the same user ID to the content-data distribution servers 163-1, 163-2, . . . , 163-m. Upon the reception of the user-ID-dependent multiple use notices, the content-data distribution servers 63-1, 163-2, . . . , 163-m control the at least two user terminals in question to prohibit the use of the content data pieces therein. Therefore, it is possible to prevent the illegal use of content data pieces in the user terminals 161-1, 161-2, . . . , 161-n. Furthermore, in the case where licenses are granted on an individual-by-individual basis, a plurality of persons can be prevented from illegally using one license.

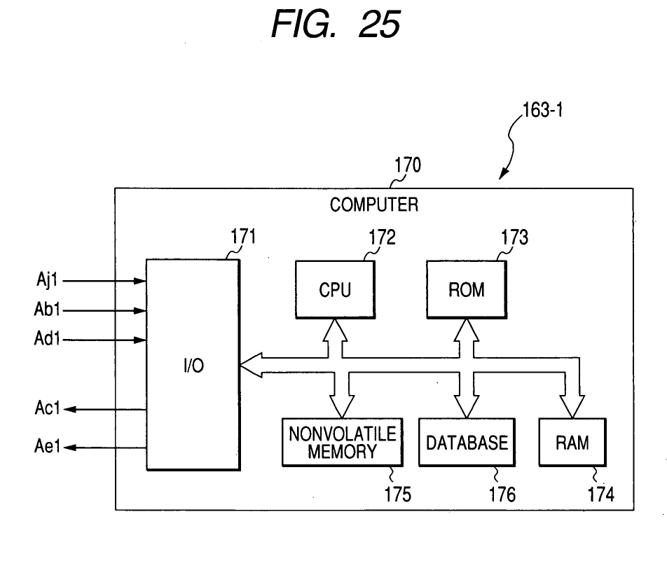

The content-data distribution server 163-1 may include a computer 170 as shown in FIG. 25. The computer 170 has a combination of an input/output (I/O) port 171, a CPU 172, a ROM 173, a RAM 174, a nonvolatile memory 175, and a database 176. The computer 170 operates in accordance with a control program (a computer program) stored in the ROM 173, the RAM 174, or the nonvolatile memory 175.

The I/O port 171 can receive a user-ID-dependent multiple use notice Aj1 from the use-condition managing apparatus 112. The I/O port 171 can receive an authentication request signal Ab1 and a content request signal Ad1 from the user terminal 161-1. The I/O port 171 can send an authentication reply signal Ac1 and a desired content data piece Ae1 to the user terminal 161-1.

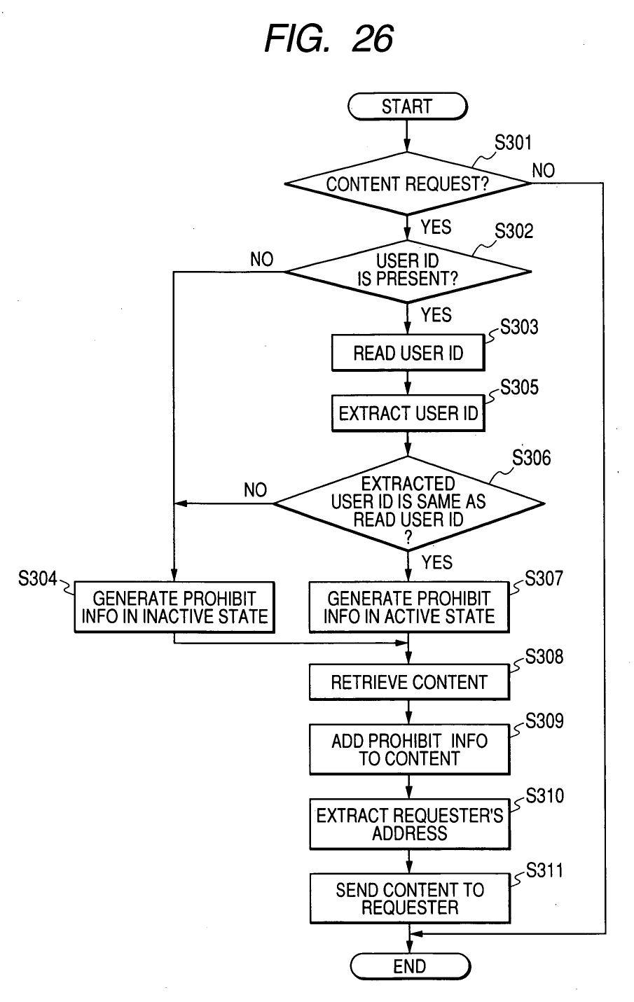

FIG. 26 is a flowchart of a first segment of the control program for the computer 170. The program segment in FIG. 26 is periodically iterated. As shown in FIG. 26, a first step S301 of the program segment decides whether or not a content request signal has just arrived. When a content request signal has just arrived, the program advances from the step S301 to a step S302. Otherwise, the program exits from the step S301 and then the current execution cycle of the program segment ends.

The step S302 accesses the nonvolatile memory 175, and decides whether or not at least one user ID (one specified user ID or one illegal user ID) is present therein. When at least one user ID is present, the program advances from the step S302 to a step S303. Otherwise, the program advances from the step S302 to a step S304.

The step S303 reads the user ID or IDs (the read specified user ID or IDs, that is, the read illegal user ID or IDs) from the nonvolatile memory 175.

A step S305 following the step S303 extracts a user ID from the content request signal.

A step S06 subsequent to the step S305 decides whether or not the extracted user ID is the same as one of the read user IDs (the read user ID). When the extracted user ID is the same as one of the read user IDs, the program advances from the step S306 to a step S307. Otherwise, the program advances from the step S306 to the step S304.

The step S307 generates content-use prohibiting information in an active state. After the step S307, the program advances to a step S308.

The step S304 generates content-use prohibiting information in an inactive state. After the step S304, the program advances to the step S308.

The step S308 retrieves a desired content data piece from the database 176 in response to the content request signal.

A step S309 following the step S308 adds the content-use prohibiting information generated by the step S304 or S307 to the desired content data piece.

A step S310 subsequent to the step S309 extracts requester's address from the content request signal.

A step S311 following the step S310 sends the desired content data piece inclusive of the content-use prohibiting information to a user terminal having an address equal to the extracted requester's address. After the step S311, the current execution cycle of the program segment ends.

According to a second segment of the control program, the computer 170 can receive an authentication request signal from a user terminal. The computer 170 implements authentication. Specifically, the computer 170 decides whether or not a user ID represented by the authentication request signal is legitimate. When the user ID is legitimate, the computer 170 generates an authentication completion signal. Otherwise, the computer 170 generates an error signal. Then, the computer 170 returns the authentication completion signal or the error signal to the user terminal as an authentication reply signal.

According to a third segment of the control program, the computer 170 can receive a user-ID-dependent multiple use notice from the use-condition managing apparatus 112. The computer 170 extracts a user ID from the received notice before storing the extracted user ID into the nonvolatile memory 175.

What is claimed is:

1. A contents-data using system comprising a plurality of data using apparatuses and a use-history-information managing apparatus;
wherein each of the data using apparatuses comprises:
first means for receiving a user ID;
second means for using content data;
third means for generating a use history information piece including a record data piece which represents a term of the use of content data by the second means and the user ID received by the first means, and which relates the term of the use of the content data by the second means and the user ID received by the first means with each other;
fourth means for sending the use history information piece generated by the third means to the use-history-information managing apparatus;
fifth means for receiving a multiple use notice from the use-history-information managing apparatus;
sixth means for deciding whether or not a user ID in the multiple use notice received by the fifth means is equal to the user ID received by the first means; and
seventh means for prohibiting the second means from using content data when the sixth means decides that the user ID in the multiple use notice received by the fifth means is equal to the user ID received by the first means;
wherein the use-history-information managing apparatus comprises:
eighth means for receiving use history information pieces from the data using apparatuses respectively;
ninth means for deciding whether or not at least two of terms represented by record data pieces in the use history information pieces received by the eighth means are related with a same user ID and at least partially overlap each other;
tenth means for, when the ninth means decides that at least two of terms represented by record data pieces in the use history information pieces received by the eighth means are related with a same user ID and at least partially overlap each other, generating a multiple use notice inclusive of the same user ID; and
eleventh means for sending the multiple use notice generated by the tenth means to the data using apparatuses.

2. A data using apparatus comprising:
first means for receiving a user ID;
second means for using content data;
third means for generating a use history information piece including a record data piece which represents a term of the use of content data by the second means and the user ID received by the first means, and which relates the term of the use of the content data by the second means and the user ID received by the first means with each other;
fourth means for sending the use history information piece generated by the third means to an external apparatus;
fifth means for receiving a multiple use notice from the external apparatus;
sixth means for deciding whether or not a user ID in the multiple use notice received by the fifth means is equal to the user ID received by the first means; and
seventh means for prohibiting the second means from using content data when the sixth means decides that the user ID in the multiple use notice received by the fifth means is equal to the user ID received by the first means.

3. A use-history-information managing apparatus comprising:
first means for receiving use history information pieces from external apparatuses respectively;
second means for deciding whether or not at least two of terms represented by record data pieces in the use history information pieces received by the first means are related with a same user ID and at least partially overlap each other;
third means for, when the second means decides that at least two of the terms are related with a same user ID and at least partially overlap each other, generating a multiple use notice inclusive of the same user ID; and
fourth means for sending the multiple use notice generated by the third means to the external apparatuses.

4. A contents-data using system comprising a content-data distributing apparatus, a plurality of data using apparatuses, and a use-history-information managing apparatus;
wherein each of the data using apparatuses comprises:
first means for receiving a user ID;
second means for receiving content data from the content-data distributing apparatus;
third means for using the content data received by the second means;
fourth means for selectively permitting and prohibiting the use of the content data by the third means in response to content-use prohibiting information in the content data received by the second means;
fifth means for generating a use history information piece including a record data piece which represents a term of the use of the content data by the third means and the user ID received by the first means, and which relates the term of the use of the content data by the third means and the user ID received by the first means with each other; and
sixth means for sending the use history information piece generated by the fifth means to the use-history-information managing apparatus;
wherein the use-history-information managing apparatus comprises:
seventh means for receiving use history information pieces from the data using apparatuses respectively;
eighth means for deciding whether or not at least two of terms represented by record data pieces in the use history information pieces received by the seventh means are related with a same user ID and at least partially overlap each other;
ninth means for, when the eighth means decides that at least two of terms represented by record data pieces in the use history information pieces received by the seventh means are related with a same user ID and at least partially overlap each other, generating a multiple use notice inclusive of the same user ID; and
tenth means for sending the multiple use notice generated by the ninth means to the content-data distributing apparatus;
wherein the content-data distributing apparatus comprises:
eleventh means for receiving a multiple use notice from the use-history-information managing apparatus;
twelfth means for extracting a user ID from the multiple use notice received by the eleventh means;
thirteenth means for generating content-use prohibiting information in response to the user ID extracted by the twelfth means;
fourteenth means for generating first content data;
fifteenth means for adding the content-use prohibiting information generated by the thirteenth means to the first content data generated by the fourteenth means to generate second content data; and
sixteenth means for distributing the second content data generated by the fifteenth means.

5. A content-data distributing apparatus comprising:
first means for receiving a multiple use notice from an external apparatus;
second means for extracting a user ID from the multiple use notice received by the first means;
third means for generating content-use prohibiting information in response to the user ID extracted by the second means;
fourth means for generating first content data;
fifth means for adding the content-use prohibiting information generated by the third means to the first content data generated by the fourth means to generate second content data; and
six means for distributing the second content data generated by the fifth means.

6. A contents-data using system comprising:
a plurality of data using apparatuses each including a data using device for using content data, and an input device for receiving a user ID before the data using device uses content data;
first means for deciding whether or not at least two apparatuses which have received a same user ID use content data during respective terms at least partially overlapping each other, the at least two apparatuses being among the data using apparatuses;
second means for, in cases where the first means decides that at least two apparatuses which have received a same user ID use content data during respective terms at least partially overlapping each other, designating the same user ID as a specified user ID;
third means for deciding whether or not a user ID newly received by any one of the data using apparatuses is equal to the specified user ID; and
fourth means for, when the third means decides that a user ID newly received by any one of the data using apparatuses is equal to the specified user ID, prohibiting the one of the data using apparatuses from using content data.

7. In a contents-data using system comprising a plurality of data using apparatuses each including a data using device for using content data, and an input device for receiving a user ID before the data using device uses content data, a method comprising the steps of:
deciding whether or not at least two apparatuses which have received a same user ID use content data during respective terms at least partially overlapping each other, the at least two apparatuses being among the data using apparatuses;
in cases where it is decided that at least two apparatuses which have received a same user ID use content data during respective terms at least partially overlapping each other, designating the same user ID as a specified user ID;
deciding whether or not a user ID newly received by any one of the data using apparatuses is equal to the specified user ID; and
when it is decided that a user ID newly received by any one of the data using apparatuses is equal to the specified user ID, prohibiting the one of the data using apparatuses from using content data.
